(19) United States
(12) Patent Application Publication
(10) Pub. No.: US 2019/0342106 A1
(43) Pub. Date: Nov. 7, 2019

(54) PHYSICALLY UNCLONABLE FUNCTION (PUF) CIRCUITS EMPLOYING MULTIPLE PUF MEMORIES TO DECOUPLE A PUF CHALLENGE INPUT FROM A PUF RESPONSE OUTPUT FOR ENHANCED SECURITY

(71) Applicant: QUALCOMM Incorporated, San Diego, CA (US)

(72) Inventors: Xia Li, San Diego, CA (US); Seung Hyuk Kang, San Diego, CA (US); Nicholas Ka Ming Stevens-Yu, Palo Alto, CA (US)

(21) Appl. No.: 15/969,043

(22) Filed: May 2, 2018

(51) Int. Cl. H04L 9/32; G11C 11/419; G11C 11/418; G06F 21/75

(52) U.S. Cl. CPC H04L 9/3278; G11C 11/419; G11C 11/412; G06F 21/75; G11C 11/418

(57) ABSTRACT

Physically unclonable function (PUF) circuits employing multiple PUF memories to decouple a PUF challenge input from a PUF response output for enhanced security. The PUF circuit includes a PUF challenge memory and a PUF response memory. In response to a read operation, the PUF challenge memory uses a received PUF challenge input data word to address PUF challenge memory arrays therein to generate a plurality of intermediate PUF challenge output data words. The PUF response memory is configured to generate a second, final PUF response output data word in response to intermediate PUF challenge output data words. In this manner, it is more difficult to learn the challenge-response behavior of the PUF circuit, because the PUF challenge input data word does not directly address a memory array that stores memory states representing final logic values in the PUF response output data word.

### BACKGROUND

### I. Field of the Disclosure

The technology of the disclosure relates generally to physically unclonable function (PUF) circuits, and more particularly to a PUF circuit employing a PUF memory array of memory bit cells for generating a PUF response output in response to a challenge input.

### II. Background

A physical unclonable function (PUF) circuit (sometimes also called a physically unclonable function (PUF)) is a physical entity that is embodied in a physical structure, and is easy to evaluate but hard to predict. A specific challenge and its corresponding response together form a challenge-response pair (CRP) or challenge-response behavior. For example, a response generated by the PUF circuit in response to a challenge may be used to authenticate a device or may be used as a cryptographic key. As another example, a mobile device may include circuitry that is configured to generate a response to a challenge for use as a basis for a device identifier of a device.

A PUF circuit's “unclonability” means that each integrated circuit (IC) employing the PUF circuit has a unique and unpredictable way of mapping challenges to responses, even if one IC is manufactured with the same process as another seemingly identical IC. PUF circuits depend on the uniqueness of their physical microstructure. Thus, because it is practically infeasible to construct a PUF circuit with the same challenge-response behavior as another PUF circuit, a PUF circuit can be included in an IC to generate unique, random information based on the underlying physical characteristics of a device.

This microstructure depends on random physical factors introduced during manufacturing. For example, in the context of ICs, an on-chip PUF is a chip-unique challenge-response mechanism exploiting manufacturing process variations inside the ICs. For example, as shown in FIG. 1, a challenge 100 is applied to a PUF circuit 102. The reaction of the PUF circuit 102 for a particular device A is called a “response” 104. A specific challenge 100 and its corresponding response 104 together form a challenge-response pair (CRP) 106 or challenge-response behavior of the PUF circuit 102 in device A. The response 104 to the challenge 100 can be provided to and stored by a server 108 for example as part of an initialization/enrollment process. Then, in an authentication process, a challenge 112 can be issued to a PUF circuit 114 for another device B requesting authorization. It is not known if device B is device A. The PUF circuit 114 issues a response 116 to the challenge 112 to the server 108. If the responses 104, 116 match, the server 108 can authenticate device B as device A.

In this regard, PUF circuits can be implemented in different technologies. As an example, a PUF cell in a PUF circuit can be provided in the form of a static random access memory (SRAM) cell. For example, FIG. 2 illustrates a PUF cell 200 in the form of an SRAM bit cell 202 that can be provided in a PUF circuit. As shown therein, the SRAM bit cell 202 is comprised of two cross-coupled inverters 204(1), 204(2). Each inverter 204(1), 204(2) includes a pull-up P-type Field-Effect Transistor (FET) (PFET) 206P(1), 206P(2) coupled to a positive voltage rail 208P having a positive supply voltage V_{DD}, and a pull-down N-type FET (NFET) 206N(1), 206N(2) coupled to a voltage rail 208N having a ground voltage or negative supply voltage V_{SS}. The cross-coupled inverters 204(1), 204(2) reinforce each other to retain data in the form of a voltage on a respective true storage output T and a complement storage output C. In a read operation, a bit line BL and complement bit line BLB are pre-charged to the positive supply voltage V_{DD}, or half positive supply voltage V_{DD} as examples. Then, a word line WL coupled to gates G of access transistors 210(1), 210(2) is asserted to evaluate the differential voltages on the true storage output T and complement storage output C to read the SRAM bit cell 202. If the SRAM bit cell 202 has not been previously written, the initial state of the SRAM bit cell 202 is determined by process variation of the pull-up PFETs 206P(1), 206P(2) and the pull-down NFETs 206N(1), 206N(2) when the word line WL is asserted to activate the access transistors 210(1), 210(2) (their gate-to-source voltage exceeding their threshold voltage V_{TH}). Thus, the SRAM bit cell 202 can be used to generate a random PUF response output. Either the true storage output T or complement storage output C can be used as the random PUF response output. The voltage state (V_{DD} or V_{SS}) on the true storage output T will eventually settle to be the opposite voltage state (V_{SS} or V_{DD}) on the complement storage output C.

Ideally, the inverters 204(1), 204(2) will be symmetrically matched so that the SRAM bit cell 202 is not skewed to favor settling to one voltage state over the other. For example, length L and threshold voltages V_{TH} of complementary pull-up PFETs 206P(1), 206P(2) and complementary pull-down NFETs 206N(1), 206N(2) can be sized to generate a same voltage noise V_{NOISE}. As shown in FIG. 3A, ideally, the SRAM bit cell 202 in FIG. 2 has a neutral skew, wherein the inverters 204(1), 204(2) are symmetrically matched to generate a PUF response output that is logic ‘0’ for approximately half of PUF read operations and logic ‘1’ for approximately the other half of the PUF read operations. However, process variations can cause the complementary pull-up PFETs 206P(1), 206P(2) and complementary pull-down NFETs 206N(1), 206N(2) in the inverters 204(1), 204(2) in the SRAM bit cell 202 in FIG. 2 to be mismatched, and thus be skewed towards one voltage state. This is shown by example in FIG. 3B. As shown in FIG. 3B, random noise σ_{NOISE} resulting from process variation Δ_{PV} skews the voltage state (i.e., neutral-skewed) of the SRAM bit cell 202 to always generate a logic ‘1’ PUF response output.

Thus, the SRAM bit cell 202 in FIG. 2 can be used to provide PUF memory cells in a PUF circuit by taking advantage of this imbalance in the inverters 204(1), 204(2) that will occur through process variation. A plurality of SRAM bit cells 202 can be used to generate random X-bit numbers at power-up through a read operation, such as chip identifications for example. The SRAM bit cells 202 would be read and not written to first to obtain a random state at power-up. Ideally, the skew of the SRAM bit cells 202 should result in the SRAM bit cells 202 generating their stored logic states in response to a read operation repeatably based on the imbalance in their inverters 204(1), 204(2). Thus, an attack may be attempted on a PUF circuit that includes the SRAM bit cells 202 to derive its challenge-response pairs (CRPs). For example, neural network circuitry may be employed to “machine learn” the responses to the different possible challenges that can be provided to the PUF circuit, thus making the PUF circuit vulnerable to machine-learning attacks for fraudulent purposes.

### SUMMARY OF THE DISCLOSURE

Aspects disclosed herein include physically unclonable function (PUF) circuits employing multiple PUF memories to decouple a PUF challenge input from a PUF response output for enhanced security. In this regard, in exemplary aspects disclosed herein, a PUF circuit includes a PUF challenge memory as a first PUF memory, and a PUF response memory as a second PUF memory. As a non-limiting example, the PUF challenge memory can be in a first logical PUF layer, and the PUF response memory can be in a second logical PUF layer. A logical PUF layer means a circuit or circuit system having a challenge input and one or more response outputs whose logic values correspond directly to stored memory states in a memory addressed by the challenge input. The PUF challenge memory includes a plurality of PUF challenge memory arrays each comprised of a plurality of memory bit cells. In response to a PUF read operation to the PUF circuit, the PUF challenge memory is configured to use a received PUF challenge input data word to address memory bit cells in the PUF challenge memory arrays therein to generate a plurality of intermediate PUF challenge output data words. These intermediate PUF challenge output data words from the PUF challenge memory arrays are not final PUF responses of the PUF circuit. Rather, these intermediate PUF challenge output data words are used to address memory bit cells in a PUF response memory array in the PUF response memory. The PUF response memory is configured to generate a second, final PUF response output data word in response to the intermediate PUF challenge output data words received as intermediate inputs from the PUF challenge memory.

In this manner, it is difficult to discern or learn and model the challenge-response behavior of the PUF circuit, because the PUF challenge input data word into the PUF circuit does not address a memory array that stores memory states representing final logic values in the PUF response output. The intermediate PUF challenge output data words are used as subsequent challenge input data words to the PUF response memory to decouple a direct relationship between the PUF challenge input data word and logic values of the PUF response output data word of the PUF circuit. Thus, the PUF circuit may be less susceptible to a machine-learning attack. Note that the PUF circuit can include more than two PUF memories and/or more than two logical PUF layers.

In this regard, in one exemplary aspect, a PUF circuit is provided. The PUF circuit comprises a PUF challenge input configured to receive a PUF challenge input data word comprising a challenge memory address. The PUF circuit also comprises a PUF challenge memory. The PUF challenge memory comprises a first PUF challenge memory array that comprises a plurality of first challenge memory bit cells each configured to store a logic state, and a first intermediate PUF challenge output coupled to the plurality of first challenge memory bit cells. The PUF challenge memory also comprises a second PUF challenge memory array that comprises a plurality of second challenge memory bit cells each configured to store a logic state, and a second intermediate PUF challenge output coupled to the plurality of second challenge memory bit cells. The PUF challenge memory also comprises a challenge memory bit cell selection input coupled to the first PUF challenge memory array and the second PUF challenge memory array, the challenge memory bit cell selection input configured to receive a challenge memory selection signal based on the challenge memory address in the PUF challenge input data word on the PUF challenge input. The PUF circuit also comprises a PUF response memory. The PUF response memory comprises a PUF response memory array comprising a plurality of response memory bit cells each configured to store a logic state, and a PUF response output coupled to the plurality of response memory bit cells. The PUF response memory also comprises a first response memory bit cell selection input coupled to the first intermediate PUF challenge output and the plurality of response memory bit cells, and a second response memory bit cell selection input coupled to the second intermediate PUF challenge output and the plurality of response memory bit cells.

In another exemplary aspect, a PUF circuit is provided. The PUF circuit comprises a means for receiving a PUF challenge input data word indicating a challenge memory address to access in a PUF circuit. The PUF circuit also comprises a means for selecting at least one first challenge memory bit cell among a plurality of first challenge memory bit cells in a first PUF challenge memory array in a PUF challenge memory in the PUF circuit based on the means for receiving the PUF challenge input data word. The PUF circuit also comprises a means for selecting at least one second challenge memory bit cell among a plurality of second challenge memory bit cells in a second PUF challenge memory array in the PUF challenge memory in the PUF circuit based on the means for receiving the PUF challenge input data word. The PUF circuit also comprises a means for generating a first intermediate PUF challenge output data word from the first PUF challenge memory array representing a logic state in response to the means for selecting the at least one first challenge memory bit cell. The PUF circuit also comprises a means for generating a second intermediate PUF challenge output data word from the second PUF challenge memory array representing a logic state in response to the means for selecting the at least one second challenge memory bit cell. The PUF circuit also comprises a means for selecting at least one response memory bit cell among a plurality of response memory bit cells in a PUF response memory array in a PUF response memory in the PUF circuit based on the means for generating the first intermediate PUF challenge output data word and the means for generating the second intermediate PUF challenge output data word. The PUF circuit also comprises a means for generating a PUF response output data word from the PUF response memory array representing a logic state of the selected at least one response memory bit cell in response to the means for selecting the at least one response memory bit cell.

In another exemplary aspect, a method of generating a PUF response output in a PUF circuit is provided. The method comprises receiving a PUF challenge input data word indicating a challenge memory address into a PUF circuit. The method also comprises selecting at least one first challenge memory bit cell among a plurality of first challenge memory bit cells in a first PUF challenge memory array in a PUF challenge memory in the PUF circuit based on the challenge memory address. The method also comprises selecting at least one second challenge memory bit cell among a plurality of second challenge memory bit cells in a second PUF challenge memory array in the PUF challenge memory in the PUF circuit based on the challenge memory address. The method also comprises generating a first intermediate PUF challenge output data word from the first PUF challenge memory array representing a logic state of the selected at least one first challenge memory bit cell. The method also comprises generating a second intermediate PUF challenge output data word from the second PUF challenge memory array representing a logic state of the selected at least one second challenge memory bit cell. The method also comprises selecting at least one response memory bit cell among a plurality of response memory bit cells in a PUF response memory array in a PUF response memory in the PUF circuit based on the first intermediate PUF challenge output data word and the second intermediate PUF challenge output data word. The method also comprises generating a PUF response output data word from the PUF response memory array representing a logic state of the selected at least one response memory bit cell.

### BRIEF DESCRIPTION OF THE FIGURES

FIG. 1 is a diagram of an exemplary initialization and authentication process of a first device registering one or more challenge-response pairs (CRPs) with a server, and a second device requesting to be authenticated by the server based on a response to an issued challenge;

FIG. 2 is a schematic diagram of an exemplary static random access memory (SRAM) bit cell that can be used as a PUF cell in a PUF circuit;

FIGS. 3A and 3B are graphs illustrating neutral skew and a logic ‘1’ memory state skew, respectively, in an SRAM bit cell;

FIG. 4 is a schematic diagram of an exemplary PUF circuit in the form of a PUF memory that includes a PUF memory array comprising a plurality of SRAM bit cells addressable by rows and columns, and supporting access circuitry;

FIG. 5 is a schematic diagram of an exemplary PUF circuit in the form of a PUF memory that includes a PUF challenge memory comprising PUF challenge memory arrays in a first logical PUF layer configured to generate intermediate PUF response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the intermediate PUF response outputs from the intermediate challenge inputs for enhanced security;

FIG. 6A is a schematic diagram of a more detailed example of the PUF circuit in FIG. 5;

FIG. 6B is a schematic diagram of an SRAM bit cell that can be a bit cell(s) in the PUF memory arrays in the PUF memories in FIG. 6A;

FIG. 7 is a flowchart illustrating an exemplary process that can be performed by a PUF circuit, including the PUF circuits in FIG. 5 or 6A, wherein intermediate PUF response output data words from the PUF challenge memory generated in response to a challenge input data word are received into a PUF response memory to generate a PUF response output data word;

FIG. 8 is another exemplary ferroelectric (Fe) SRAM bit cell that can be a bit cell(s) in the PUF memory arrays in the PUF memories in FIG. 6A;

FIG. 9 is a schematic diagram of another exemplary PUF circuit in the form of a PUF memory that includes a first PUF challenge memory comprising PUF challenge memory arrays in a first logical PUF layer configured to generate intermediate PUF response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, wherein memory bit cells in the PUF memory arrays support an active high read enable input for controlling a read operation mode;

FIG. 10 is an exemplary Fe SRAM bit cell that can be a bit cell(s) in the PUF memory arrays in the PUF memories in FIG. 9;

FIG. 11 is a schematic diagram of another exemplary PUF circuit in the form of a PUF memory that includes a first PUF challenge memory comprising PUF challenge memory arrays in a first logical PUF layer configured to generate intermediate PUF response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, wherein the PUF memory arrays and their memory bit cells support an active low read enable input for controlling a read operation mode;

FIG. 12 is an exemplary Fe SRAM bit cell that can be a bit cell(s) in the PUF memory arrays in the PUF memories in FIG. 11;

FIG. 13 is a schematic diagram of another exemplary PUF circuit in the form of a PUF memory that includes a first PUF challenge memory comprising PUF challenge memory arrays in a first logical PUF layer configured to generate intermediate PUF response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, wherein the PUF memory arrays and their memory bit cells support an equalization input for controlling an internal pre-charge operation mode and an active low read enable input for controlling a read operation mode;

FIG. 14A is an exemplary SRAM bit cell that can be a bit cell(s) in the PUF memory arrays in the PUF memories in FIG. 13;

FIG. 14B is another exemplary SRAM bit cell that can be a bit cell(s) in the PUF memory arrays in the PUF memories in FIG. 13;

FIG. 14C is another exemplary SRAM bit cell that can be a bit cell(s) in the PUF memory arrays in the PUF memories in FIG. 13;

FIG. 14D is another exemplary SRAM bit cell that can be a bit cell(s) in the PUF memory arrays in the PUF memories in FIG. 13;

FIG. 14E is another exemplary SRAM bit cell that can be a bit cell(s) in the PUF memory arrays in the PUF memories in FIG. 13;

FIG. 14F is an exemplary Fe SRAM bit cell that can be a bit cell(s) in the PUF memory arrays in the PUF memories in FIG. 13;

FIG. 14G is another exemplary Fe SRAM bit cell that can be a bit cell(s) in the PUF memory arrays in the PUF memories in FIG. 13;

FIG. 14H is another exemplary Fe SRAM bit cell that can be a bit cell(s) in the PUF memory arrays in the PUF memories in FIG. 13;

FIG. 15 illustrates a PUF memory array comprised of SRAM bit cells that can be employed as any PUF memory array in the PUF memories in FIGS. 5-6B and 8-14H, with stress voltage being applied to pull-up PFETs in inverters in the SRAM bit cells identified as being weaker than their counterpart pull-up PFETs in their cross-coupled inverters to increase natural logic state skews of the SRAM bit cells;

FIG. 16 illustrates a PUF memory array comprised of SRAM bit cells that can employed in a PUF memory, including but not limited to the PUF memories in FIGS. 5-6B and 8-14H, with stress voltage being applied to pull-down NFETs in the inverters in the SRAM bit cells identified as being weaker than their counterpart pull-down NFETs in their cross-coupled inverters to increase a natural logic state skew of the SRAM bit cells;

FIG. 17A illustrates an SRAM bit cell in the PUF memory array in the PUF memory in FIG. 6A with a logic ‘0’ stored on its true complement output;

FIG. 17B is a table illustrating an exemplary likelihood probability analysis of a logic state stored in the SRAM bit cell in FIG. 17A based on different strength comparisons between pull-up PFETs and pull-down NFETs in the cross-coupled inverters in the SRAM bit cell;

FIG. 17C illustrates exemplary Bayesian probability calculations of the natural logic state skew of the SRAM bit cell in FIG. 17A based on the likelihood probability analysis in FIG. 17B and a read logic state stored in the SRAM bit cell;

FIG. 18 illustrates formulas for the Bayesian probability calculations in FIG. 17C for a natural logic state skew of ‘0’ in the SRAM bit cell in FIG. 17A;

FIG. 19 is a graph illustrating a Bayesian inference probability curve for a natural logic state skew of ‘0’ based on the Bayesian probability calculations in FIGS. 17C and 18;

FIG. 20 illustrates formulas for the Bayesian probability calculations in FIG. 17C for a natural logic state skew of ‘0’ in the SRAM bit cell in FIG. 17A;

FIG. 21 is a graph illustrating a Bayesian inference probability curve for a natural logic state skew of ‘1’ based on the Bayesian probability calculations in FIGS. 17C and 20;

FIG. 22 is a block diagram of an exemplary processor-based system that can include a PUF circuit that includes a PUF memory, including but not limited to the PUF memories in FIGS. 5, 6A, 9, 11, and 13, that includes a first PUF challenge memory comprising PUF challenge memory arrays in a first logical PUF layer configured to generate intermediate PUF response outputs in response to an intermediate challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the intermediate challenge input for enhanced security; and

FIG. 23 is a block diagram of an exemplary wireless communications device that includes radio frequency (RF) components formed in an integrated circuit (IC), wherein any of the components therein can include a PUF circuit that includes a PUF memory, including but not limited to the PUF memories in FIGS. 5, 6A, 9, 11, and 13, that includes a first PUF challenge memory comprising PUF challenge memory arrays in a first logical PUF layer configured to generate intermediate PUF response outputs in response to an intermediate challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the intermediate challenge input for enhanced security.

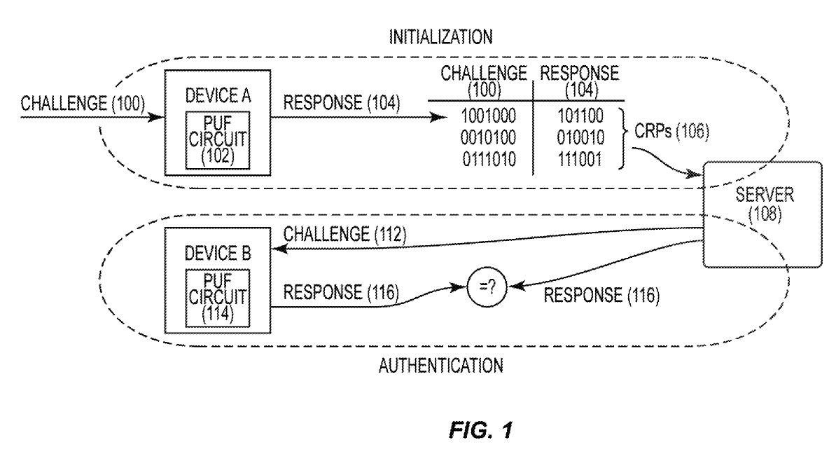

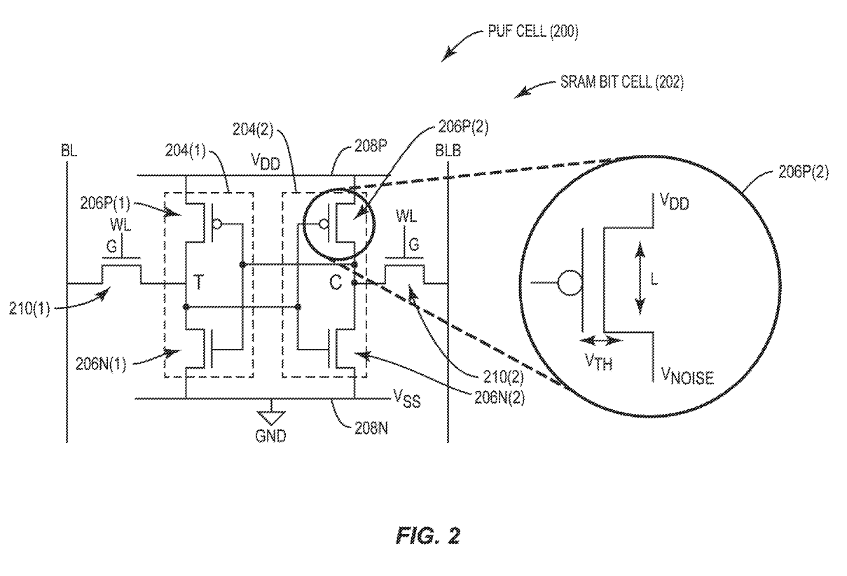

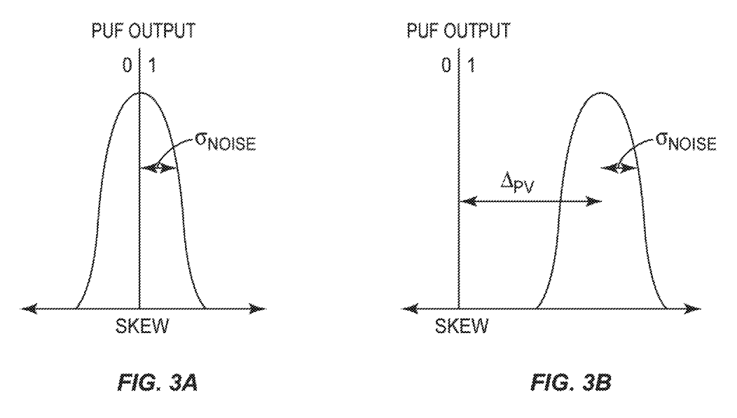

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed herein include physically unclonable function (PUF) circuits employing multiple PUF memories to decouple a PUF challenge input from a PUF response output for enhanced security. In this regard, in exemplary aspects disclosed herein, a PUF circuit includes a PUF challenge memory as a first PUF memory, and a PUF response memory as a second PUF memory. As a non-limiting example, the PUF challenge memory can be in a first logical PUF layer, and the PUF response memory can be in a second logical PUF layer. A logical PUF layer means a circuit or circuit system having a challenge input and one or more response outputs whose logic values correspond directly to stored memory states in a memory addressed by the challenge input. The PUF challenge memory includes a plurality of PUF challenge memory arrays each comprised of a plurality of memory bit cells. In response to a PUF read operation to the PUF circuit, the PUF challenge memory is configured to use a received PUF challenge input data word to address memory bit cells in the PUF challenge memory arrays therein to generate a plurality of intermediate PUF challenge output data words. These intermediate PUF challenge output data words from the PUF challenge memory arrays are not final PUF responses of the PUF circuit. Rather, these intermediate PUF challenge output data words are used to address memory bit cells in a PUF response memory array in the PUF response memory. The PUF response memory is configured to generate a second, final PUF response output data word in response to the intermediate PUF challenge output data words received as intermediate inputs from the PUF challenge memory.

In this manner, it is difficult to discern or learn and model the challenge-response behavior of the PUF circuit, because the PUF challenge input data word into the PUF circuit does not address a memory array that stores memory states representing final logic values in the PUF response output. The intermediate PUF challenge output data words are used as subsequent challenge input data words to the PUF response memory to decouple a direct relationship between the PUF challenge input data word and logic values of the PUF response output data word of the PUF circuit. Thus, the PUF circuit may be less susceptible to a machine-learning attack. Note that the PUF circuit can include more than two PUF memories and/or more than two logical PUF layers.

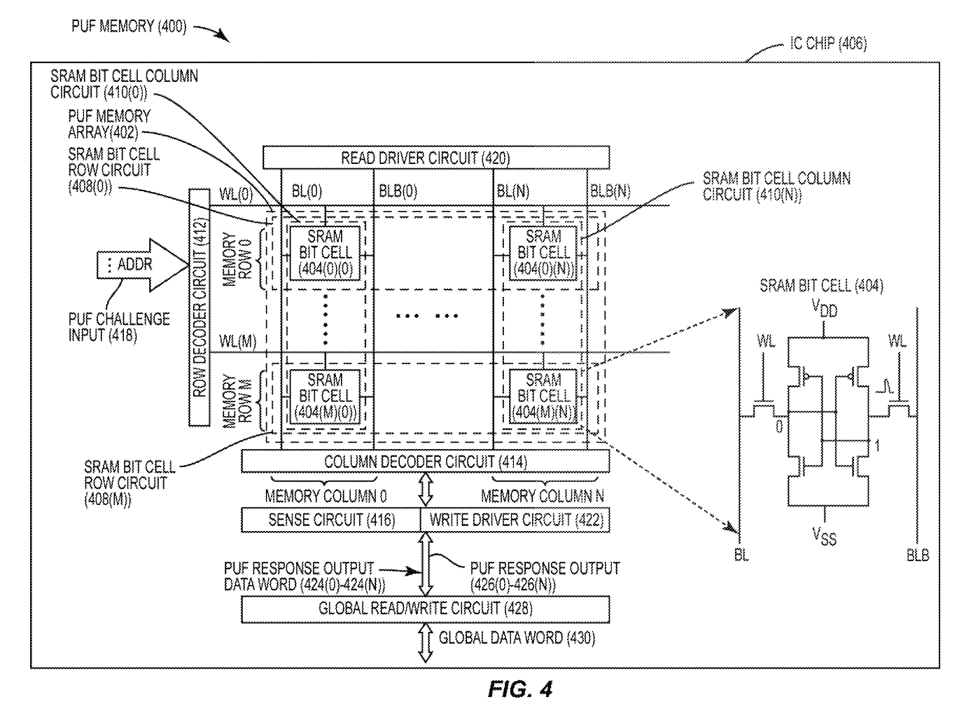

Before discussing examples of PUF circuits employing multiple PUF memories to decouple a PUF challenge input from a PUF response output for providing additional security, an exemplary PUF memory that does not include multiple PUF memories to decouple a PUF challenge input from a PUF response output is first discussed with regard to FIG. 4.

In this regard, FIG. 4 is a block diagram of an exemplary PUF memory 400 that includes a PUF memory array 402 comprised of a plurality of SRAM bit cells 404(0)(0)-404(M)(N) to support PUF operations. The PUF memory 400 may be provided on a separate IC chip 406 from a processor or integrated into a same IC chip as a processor. In this example, the PUF memory array 402 includes the plurality of SRAM bit cells 404(0)(0)-404(M)(N) organized into ‘M+1’ memory rows 0-M and ‘N+1’ memory columns 0-N. Each SRAM bit cell 404(0)(0)-404(M)(N) is configured to generate an output with logic states representing stored memory states. The PUF memory array 402 includes a plurality of SRAM bit cell row circuits 408(0)-408(M) each provided in a respective memory row 0-M. Each SRAM bit cell row circuit 408(0)-408(M) includes a plurality of SRAM bit cells 4040(0)-4040(N) each provided in a respective memory column 0-N for generating a PUF response output. The SRAM bit cells 404(0)(0)-404(M)(N) are also organized in their respective memory columns 0-N to form respective SRAM bit cell column circuits 410(0)-410(N). Each SRAM bit cell column circuit 410(0)-410(M) includes a plurality of SRAM bit cells 404(0)0-404(M)0 each provided in a respective memory row 0-M.

With continuing reference to FIG. 4, the PUF memory 400 includes a row decoder circuit 412, a challenge column decoder circuit 414, and a sense circuit 416. The row decoder circuit 412 is coupled to the PUF memory array 402 via word lines WL(0)-WL(M). Word lines WL(0)-WL(M) are coupled to the SRAM bit cells 404(0)(0)-404(M)(N) in the respective SRAM bit cell row circuits 408(0)-408(M). The row decoder circuit 412 is configured to assert one or more word lines WL(0)-WL(M) in response to a particular memory address ADDR on a PUF challenge input 418 received by the PUF memory 400 to initiate a PUF access (e.g., read) operation to the PUF memory array 402. The challenge column decoder circuit 414 is coupled to the PUF memory array 402 via bit lines BL(0)-BL(N) and complement bit lines BLB(0)-BLB(N). A read driver circuit 420 is provided to and coupled to the SRAM bit cell column circuits 410(0)-410(N) to pre-charge the bit lines BL(0)-BL(N) and a complement bit lines BLB(0)-BLB(N) with voltages to setup a read operation to the SRAM bit cells 404(0)(0)-404(M)(N) in a selected SRAM bit cell row circuit 408(0)-408(M). A write driver circuit 422 is coupled to the SRAM bit cell column circuits 410(0)-410(N) to generate a write voltage on the bit lines BL(0)-BL(N) and complement bit lines BLB(0)-BLB(N) to write data from an SRAM bit cell 404(0)(0)-404(M)(N) in a selected SRAM bit cell row circuit 408(0)-408(M).

With continuing reference to FIG. 4, the sense circuit 416 may be coupled to the PUF memory array 402 via the bit lines BL(0)-BL(N) and the complement bit lines BLB(0)-BLB(N). The sense circuit 416 may be configured to generate a PUF response output data word 424(0)-424(N) on a PUF response output 426(0)-426(N) of ‘N+1’ bits. The logic states of the PUF response output data word 424(0)-424(N) on the PUF response output 426(0)-426(N) is based on the sensed voltages on the bit lines BL(0)-BL(N) and the complement bit lines BLB(0)-BLB(N) in response to a PUF read operation. The voltages of the bit lines BL(0)-BL(N) and the complement bit lines BLB(0)-BLB(N) during a read phase are indicative of the memory state of the SRAM bit cells 404(0)(0)-404(M)(N) coupled to the bit lines BL(0)-BL(N) and the complement bit lines BLB(0)-BLB(N). For example, in response to a PUF read operation, the read driver circuit 420 asserts and de-asserts control signals to cause the SRAM bit cells 404(0)(0)-404(M)(N) in the selected SRAM bit cell row circuit 408(0)-408(M) according to the activated word line WL(0)-WL(M) generated by the row decoder circuit 412 to generate the PUF response output data word 424(0)-424(N) on the PUF response output 426(0)-426(N). To illustrate, PUF response output data word 424(0)-424(N) (e.g., a “response”) may be generated by the PUF memory array 402 in response to a particular memory address (e.g., a “challenge”). In this manner, the PUF memory array 402 may output different PUF response output data words 424(0)-424(N) (e.g., different “responses”) based on different addresses (e.g., different “challenges”). The PUF response output data word 424(0)-424(N) can be provided to a global read/write circuit 428 to provide a global data word 430 in a processor.

Thus, as shown in FIG. 4, the PUF response output data word 424(0)-424(N) is generated on the PUF response output 426(0)-426(N) by the PUF memory array 402 based on the logic values corresponding directly to stored memory states in the SRAM bit cells 404(0)(0)-404(M)(N) in the selected SRAM bit cell row circuit 408(0)-408(M) addressed by the memory address ADDR as the PUF challenge input 418. The PUF memory array 402 is configured to repeatedly generate the same PUF response output data words 424(0)-424(N) in response to the same memory address ADDR on the PUF challenge input 418. While it may be possible for a circuit or other device to learn the input/response output characteristics, it is more difficult to discern or learn and model responses of the PUF response output data words 424(0)-424(N) for the different possibilities of memory addresses ADDR provided on the PUF challenge input 418. This can make the PUF memory 400 susceptible to a machine-learning attack.

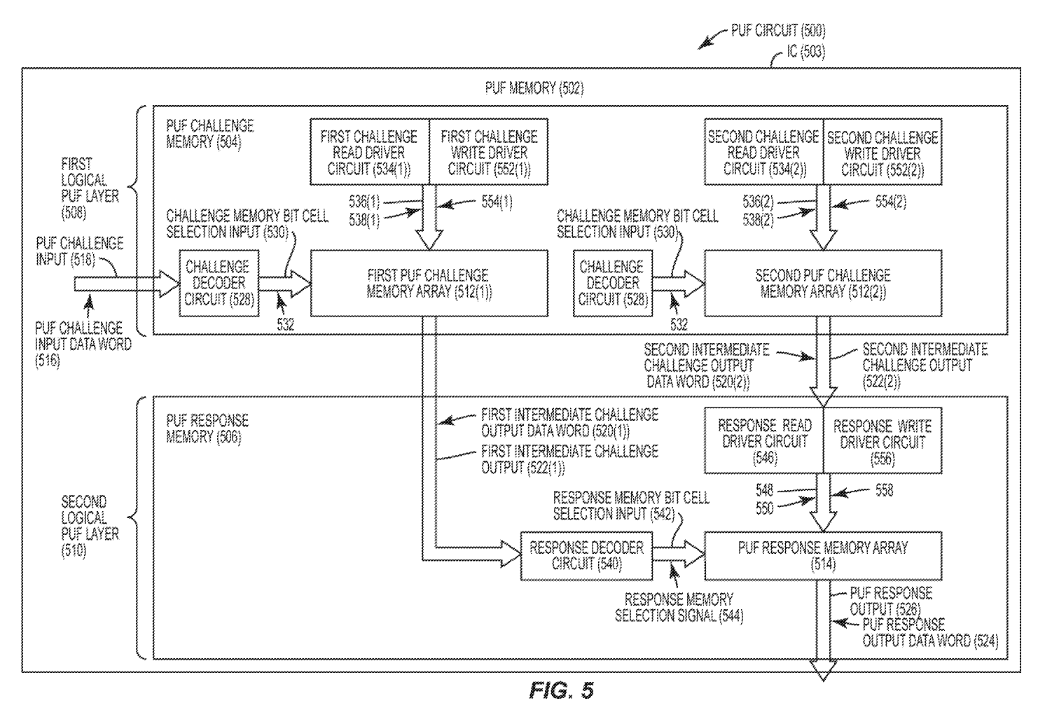

In this regard, FIG. 5 is a schematic diagram of an exemplary PUF circuit 500 in the form of a PUF memory 502 that includes multiple PUF memories to decouple a PUF challenge input from a PUF response output for providing additional security. The PUF circuit 500 may be included in an IC 503. In this regard, the PUF memory 502 includes a PUF challenge memory 504 as a first PUF memory, and a PUF response memory 506 as a second PUF memory. As a non-limiting example, the PUF challenge memory 504 can be in a first logical PUF layer 508, and the PUF response memory 506 can be in a second logical PUF layer 510. A logical PUF layer means a circuit or circuit system having a challenge input and one or more response outputs whose logic values correspond directly to stored memory states in a memory addressed by the challenge input. The PUF challenge memory 504 in this example includes two (2) PUF challenge memory arrays 512(1), 512(2) each comprised of a plurality of memory bit cells. The PUF response memory 506 in this example includes a PUF response memory array 514 comprised of a plurality of memory bit cells. In response to a PUF read operation to the PUF circuit 500, the PUF challenge memory arrays 512(1), 512(2) are configured to use a received PUF challenge input data word 516 on a PUF challenge input 518 to address memory bit cells in their respective PUF challenge memory arrays 512(1), 512(2) to generate respective first and second intermediate PUF challenge output data words 520(1), 520(2) on first and second intermediate PUF challenge outputs 522(1), 522(2). These first and second intermediate PUF challenge output data words 520(1), 520(2) from the PUF challenge memory arrays 512(1), 512(2) are not the final PUF response output of the PUF circuit 500. Rather, these first and second intermediate PUF challenge output data words 520(1), 520(2) are used to address memory bit cells in the PUF response memory array 514 in the PUF response memory 506. The PUF response memory array 514 is configured to generate a second, final PUF response output data word 524 on a PUF response output 526 in response to the first and second intermediate PUF challenge output data words 520(1), 520(2) received into the PUF response memory 506 from the PUF challenge memory 504.

In this manner, it is more difficult to discern or learn and model the challenge-response behavior of the PUF circuit 500 in FIG. 5, because the first and second intermediate PUF challenge output data words 520(1), 520(2) input into the PUF circuit 500 do not address a memory array that stores memory states representing final logic state values for the PUF response output data word 524. Rather, the first and second intermediate PUF challenge output data words 520(1), 520(2) are used as subsequent challenge inputs to the PUF response memory 506 to decouple a direct relationship between the received PUF challenge input data word 516 on the PUF challenge input 518 and logic values of the PUF response output data word 524 on the PUF response output 526. Thus, the PUF circuit 500 may be less susceptible to a machine-learning attack. Note that the PUF circuit 500 can include more than two (2) PUF challenge memories and/or more than two (2) logical PUF layers. Also note that a data word as used herein can be one bit in data width or multiple bits in data width. More exemplary detail is included in the PUF circuit 500 in FIG. 5, which will now be discussed.

The PUF challenge memory 504 includes a challenge decoder circuit 528. Two (2) challenge decoder circuits 528 are shown in the PUF challenge memory 504 in FIG. 5, but one challenge decoder circuit 528 can be employed. The challenge decoder circuit 528 is coupled to the PUF challenge input 518 and configured to receive the PUF challenge input data word 516, which can be a memory address for example. The challenge decoder circuit 528 is also coupled to a challenge memory bit cell selection input 530 that is coupled to the first PUF challenge memory array 512(1) and the second PUF challenge memory array 512(2). The challenge decoder circuit 528 is configured to decode the PUF challenge input data word 516 on the PUF challenge input 518 and generate a challenge memory selection signal 532 on the challenge memory bit cell selection input 530 as a result. The challenge memory selection signal 532 causes one or more memory bit cells in the first PUF challenge memory array 512(1) and the second PUF challenge memory array 512(2) to be accessed. The challenge decoder circuit 528 is enabled for PUF read and write operations to the PUF memory 502.

The PUF challenge memory 504 also includes a first challenge read driver circuit 534(1) coupled to a first challenge memory bit cell column input 536(1) of the first PUF challenge memory array 512(1), and a second challenge read driver circuit 534(2) coupled to a second challenge memory bit cell column input 536(2) of the second PUF challenge memory array 512(2). The first challenge read driver circuit 534(1) and the second challenge read driver circuit 534(2) are each configured to assert respective first and second challenge read signals 538(1), 538(2) on the first and second challenge memory bit cell column inputs 536(1), 536(2). The respective first and second challenge read signals 538(1), 538(2) place the one or more accessed memory bit cells in the first and second PUF challenge memory arrays 512(1), 512(2) in a state for their stored memory states to be read and output as the first and second intermediate PUF challenge output data words 520(1), 520(2) in response to a PUF read operation.

With continuing reference to FIG. 5, the PUF response memory 506 includes a response decoder circuit 540. The response decoder circuit 540 is coupled to the first intermediate PUF challenge output 522(1) and is configured to receive the first intermediate PUF challenge output data word 520(1) generated by the first PUF challenge memory array 512(1). The response decoder circuit 540 is also coupled to a response memory bit cell selection input 542 that is coupled to the PUF response memory array 514. The response decoder circuit 540 is configured to decode the first intermediate PUF challenge output data word 520(1) on the first intermediate PUF challenge output 522(1) and generate a response memory selection signal 544 on the response memory bit cell selection input 542 as a result. The response memory selection signal 544 causes one or more memory bit cells in the PUF response memory array 514 to be accessed. The PUF response memory 506 also includes a response read driver circuit 546 coupled to a response memory bit cell column input 548 of the PUF response memory array 514. The response read driver circuit 546 is configured to assert a respective response read signal 550 on the response memory bit cell column input 548. The response read signal 550 places the one or more accessed memory bit cells in the PUF response memory array 514 in a state for their stored memory states to be read and output as the PUF response output data word 524 on the PUF response output 526 in response to a PUF read operation.

As will be discussed in more detail below, it may also be desired to be able to perform write operations to the PUF memory 502 in FIG. 5. For example, it may be desired to conduct write operations to the first and second PUF challenge memory arrays 512(1), 512(2) and/or the PUF response memory array 514 to enhance the natural logic state skew of the memory bit cells therein before conducting PUF read operations to enhance the reproducibility of the PUF response output data word 524.

In this regard, the PUF challenge memory 504 also includes a first challenge write driver circuit 552(1) coupled to the first challenge memory bit cell column input 536(1) of the first PUF challenge memory array 512(1) and a second challenge write driver circuit 552(2) coupled to the second challenge memory bit cell column input 536(2) of the second PUF challenge memory array 512(2). The first challenge write driver circuit 552(1), and second challenge write driver circuit 552(2) are each configured to assert respective first and second challenge write signals 554(1), 554(2) on the first and second challenge memory bit cell column inputs 536(1), 536(2). The respective first and second challenge write signals 538(1), 538(2) are signals representing logic values to be stored in the one or more accessed memory bit cells in the first and second PUF challenge memory arrays 512(1), 512(2) in response to a PUF write operation. The PUF response memory 506 includes a response write driver circuit 556 coupled to the response memory bit cell column input 548 of the PUF response memory array 514. The response write driver circuit 556 is configured to assert a response write signal 558 on the response memory bit cell column input 548. The respective response write signal 558 is a signal representing a logic value to be stored in the one or more accessed memory bit cells in the PUF response memory array 514 in response to a PUF write operation.

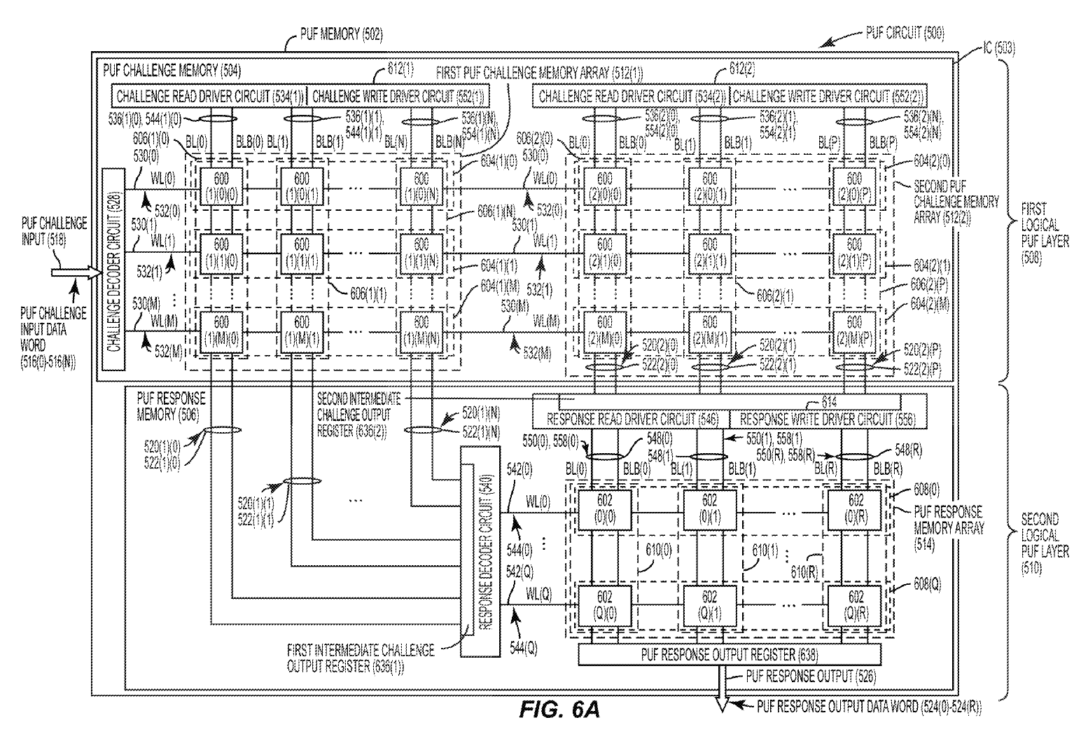

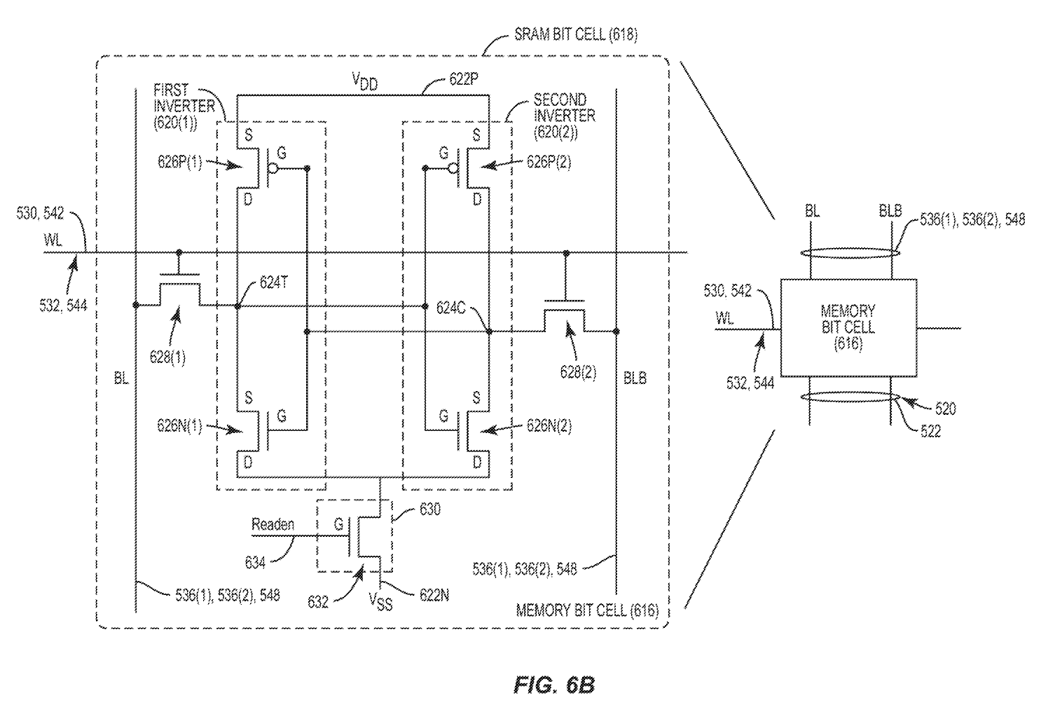

FIG. 6A is a schematic diagram of a more detailed example of the PUF circuit 500 in FIG. 5 that that includes a PUF memory 502. Common elements between FIGS. 5 and 6A are shown with common element numbers and will not be re-described. As shown in FIG. 6A, the first PUF challenge memory array 512(1) includes challenge memory bit cells 600(1)(0)(0)-600(1)(M)(N) addressable by 0-M memory rows and 0-N memory columns. The second PUF challenge memory array 512(2) includes challenge memory bit cells 600(1)(0)(0)-600(1)(M)(P) also addressable by 0-M memory rows and 0-P memory columns. The PUF response memory array 514 includes response memory bit cells 602(0)(0)-602(Q)(R) also addressable by 0-Q memory rows and 0-R memory columns. FIG. 6B illustrates an exemplary memory bit cell in the form of an SRAM bit cell 618 that can be any of the challenge memory bit cells 600(1)(0)(0)-600(1)(M)(N), 600(1)(0)(0)-600(1)(M)(P), 602(0)(0)-602(Q)(R) in the PUF memory 502. The PUF memory 502 also includes supporting access circuitry used to perform read and write operations to the memory bit cells 600(1)(0)(0)-600(1)(M)(N), 600(1)(0)(0)-600(1)(M)(P), and 602(0)(0)-602(Q)(R).

With reference to FIG. 6A, each memory bit cell 600(1)(0)(0)-600(1)(M)(N), 600(1)(0)(0)-600(1)(M)(P), 602(0)(0)-602(Q)(R) is configured to generate an output to represent a stored memory state. For example, in this example, each memory bit cell 600(1)(0)(0)-600(1)(M)(N), 600(1)(0)(0)-600(1)(M)(P), 602(0)(0)-602(Q)(R) may be a 6-T transistor circuit SRAM bit cell as shown in FIG. 6B. The first PUF challenge memory array 512(1) includes a plurality of memory bit cell row circuits 604(1)(0)-604(1)(M) each provided in a respective memory row 0-M. Each memory bit cell row circuit 604(1)(0)-604(1)(M) includes a plurality of memory bit cells 600(1)0(0)-600(1)0(N) each provided in a respective memory column 0-N for generating the first intermediate PUF challenge output data word 520(1)(0)-520(1)(N). The second PUF challenge memory array 512(2) includes a plurality of challenge memory bit cell row circuits 604(2)(0)-604(2)(M) each provided in a respective memory row 0-M. Each challenge memory bit cell row circuit 604(2)(0)-604(2)(M) includes the plurality of challenge memory bit cells 600(2)0(0)-600(2)0(P) each provided in a respective memory column 0-P for generating the second intermediate PUF challenge output data word 520(2)(0)-520(2)(P). The challenge memory bit cells 600(1)(0)(0)-600(1)(M)(N), 600(2)(0)(0)-600(2)(M)(P) are also organized in their respective memory columns 0-N and 0-P to form respective challenge memory bit cell column circuits 606(1)(0)-606(1)(N), 606(2)(0)-606(2)(P). Each memory bit cell column circuit 606(1)(0)-606(1)(N), 606(2)(0)-606(2)(P) includes a respective plurality of challenge memory bit cells 600(1)(0)(0)-600(1)(M)(N), 600(2)(0)(0)-600(2)(M)(P) each provided in a respective memory row 0-M.

With reference to FIG. 6A, the PUF response memory array 514 includes a plurality of response memory bit cell row circuits 608(0)-608(Q) each provided in a respective memory row 0-Q. Each response memory bit cell row circuit 608(0)-608(Q) includes the plurality of response memory bit cells 6020(0)-6020(R) each provided in a respective memory column 0-P for generating a PUF response output data word 524(0)-524(R). The challenge memory bit cells 600(1)(0)(0)-600(1)(M)(N), 600(2)(0)(0)-600(2)(M)(P) are also organized in their respective memory columns 0-N and 0-P to form respective response memory bit cell column circuits 610(0)-610(R). Each response memory bit cell column circuit 610(0)-610(R) includes a respective plurality of response memory bit cells 602(0)(0)-602(Q)(R) each provided in a respective memory row 0-Q.

With continuing reference to FIG. 6A, the PUF memory 502 includes the challenge decoder circuit 528, and first and second challenge column decoder circuits 612(1), 612(2). The first and second challenge column decoder circuits 612(1), 612(2) include the respective challenge read driver circuits 534(1), 534(2) and challenge write driver circuits 552(1), 552(2). The challenge decoder circuit 528 is coupled to the first and second PUF challenge memory arrays 512(1), 512(2) via word lines WL(0)-WL(M) as challenge memory bit cell selection inputs 530(0)-530(M). Word lines WL(0)-WL(M) are coupled to the challenge memory bit cells 600(1)(0)(0)-600(1)(M)(N), 600(2)(0)(0)-600(2)(M)(P) in the respective challenge memory bit cell row circuits 604(1)(0)-604(1)(M), 604(2)(0)-604(2)(M). The challenge decoder circuit 528 is configured to assert one or more word lines WL(0)-WL(M) in response to a particular PUF challenge input data word 516(0)-516(N) received on the PUF challenge input 518 by the PUF memory 502 to initiate a PUF access (e.g., read) operation to the PUF memory 502. The first challenge column decoder circuit 612(1) is coupled to the first PUF challenge memory array 512(1) via bit lines BL(0)-BL(N) and complement bit lines BLB(0)-BLB(N). Respective pairs of bit lines BL(0)-BL(N) and complement bit lines BLB(0)-BLB(N) are examples of first challenge memory bit cell column inputs 536(1)(0)-536(1)(N) and first challenge write signals 554(1)(0)-554(1)(N). The second challenge column decoder circuit 612(2) is coupled to the second PUF challenge memory array 512(2) via bit lines BL(0)-BL(P) and complement bit lines BLB(0)-BLB(P). A respective pair of lines BL(0)-BL(P) and complement bit lines BLB(0)-BLB(P) are examples of second challenge memory bit cell column inputs 536(2)(0)-536(2)(N) and second challenge write signals 554(2)(0)-554(2)(N). The first and second challenge read driver circuits 534(1), 534(2) are configured to pre-charge the respective bit lines BL(0)-BL(N), BL(0)-BL(P) and respective complement bit lines BLB(0)-BLB(N), BL(0)-BL(P) with voltages to setup a read operation to the respective challenge memory bit cells 600(1)(0)(0)-600(1)(M)(N), 600(2)(0)(0)-600(2)(M)(P) in a selected challenge memory bit cell row circuit 604(1)(0)-604(1)(M), 604(2)(0)-604(2)(M) according to the PUF challenge input data word 516(0)-516(N). The first and second write driver circuits 552(1), 552(2) are each configured to generate a write voltage on the respective bit lines BL(0)-BL(N), BL(0)-BL(P) and respective complement bit lines BLB(0)-BLB(N), BLB(0)-BLB(P) for a write operation to the respective challenge memory bit cells 600(1)(0)(0)-600(1)(M)(N), 600(2)(0)(0)-600(2)(M)(P) in a selected challenge memory bit cell row circuit 604(1)(0)-604(1)(M), 604(2)(0)-604(2)(M) according to the PUF challenge input data word 516(0)-516(N).

With continuing reference to FIG. 6A, the first and second PUF challenge memory arrays 512(1), 512(2) are each configured to generate the respective first and second intermediate PUF challenge output data words 520(1)(0)-520(1)(N), 520(2)(0)-520(2)(P) on the first and second intermediate PUF challenge outputs 522(1)(0)-522(1)(M), 522(2)(0)-522(2)(P) of ‘N+1’ bits and ‘P+1’ bits, respectively. A logic state of the first and second intermediate PUF challenge output data words 520(1)(0)-520(1)(N), 520(1)(0)-520(1)(P) is based on the sensed voltages on the respective bit lines BL(0)-BL(N) and the complement bit lines BLB(0)-BLB(N), the bit lines BL(0)-BL(P) and the complement bit lines BLB(0)-BLB(P) in response to a PUF read operation. The voltages of the respective bit lines BL(0)-BL(N) and the complement bit lines BLB(0)-BLB(N), the bit lines BL(0)-BL(P) and the complement bit lines BLB(0)-BLB(P) during a read phase are indicative of the memory state of the challenge memory bit cells 600(1)(0)(0)-600(1)(M)(N), 600(2)(0)(0)-600(2)(M)(P) selected to be coupled to the respective bit lines BL(0)-BL(N) and the complement bit lines BLB(0)-BLB(N), and the bit lines BL(0)-BL(P) and the complement bit lines BLB(0)-BLB(P). In this manner, the first and second PUF challenge memory arrays 512(1), 512(2) can output different first and second intermediate PUF challenge output data words 520(1)(0)-520(1)(N), 520(2)(0)-520(2)(P) based on different PUF challenge input data words 516(0)-516(N) as memory addresses (e.g., different “challenges”).

With continuing reference to FIG. 6A, the PUF memory 502 includes the response decoder circuit 540 and a response challenge column decoder circuit 614. The response challenge column decoder circuit 614 includes the respective response read driver circuit 546 and the response write driver circuit 556. The response decoder circuit 540 is coupled to the PUF response memory array 514 via word lines WL(0)-WL(Q) as the response memory bit cell selection inputs 542(0)-542(Q). Word lines WL(0)-WL(Q) are coupled to the response memory bit cells 602(0)(0)-602(Q)(R) in the respective response memory bit cell row circuits 608(0)-608(Q). The response decoder circuit 540 is configured to assert one or more word lines WL(0)-WL(Q) in response to the first intermediate PUF challenge output data word 520(1)(0)-520(1)(N) received on the first intermediate PUF challenge output 522(1)(0)-522(1)(M) by the first PUF challenge memory array 512(1) to initiate a PUF access (e.g., read) operation to the PUF response memory array 514. The response challenge column decoder circuit 614 is coupled to the second PUF challenge memory array 512(2) and is coupled to bit lines BL(0)-BL(R) and complement bit lines BLB(0)-BLB(R). Respective pairs of bit lines BL(0)-BL(R) and complement bit lines BLB(0)-BLB(R) are examples of response memory bit cell column inputs 548(0)-548(R). The response read driver circuit 546 is configured to pre-charge the respective bit lines BL(0)-BL(R) and complement bit lines BLB(0)-BLB(R) with voltages based on the second intermediate PUF challenge output data word 520(2)(0)-520(2)(P) to setup a read operation to the respective response memory bit cells 602(0)(0)-602(Q)(R), in a selected response memory bit cell row circuit 608(0)-608(Q) according to the second intermediate PUF challenge output data word 520(2)(0)-520(2)(P). The response write driver circuit 556 is configured to generate a write voltage on the respective bit lines BL(0)-BL(R) and complement bit lines BLB(0)-BLB(R) for a write operation to the respective response memory bit cells 602(0)(0)-602(Q)(R) in a selected response memory bit cell row circuit 608(0)-608(Q) according to the first intermediate PUF challenge output data word 520(1)(0)-520(1)(N).

With continuing reference to FIG. 6A, the PUF response memory array 514 is configured to generate the PUF response output data word 524(0)-524(R) of ‘R+1’ bits. A logic state of the PUF response output data word 524(0)-524(R) is based on the sensed voltages on the respective bit lines BL(0)-BL(R) and the complement bit lines BLB(0)-BLB(R) in the PUF response memory array 514 in response to a PUF read operation. The voltages of the respective bit lines BL(0)-BL(R) and the complement bit lines BLB(0)-BLB(R) during a read phase are indicative of the memory state of the challenge memory bit cells 600(1)(0)(0)-600(1)(M)(N), 600(2)(0)(0)-600(2)(M)(P) selected to be coupled to the respective bit lines BL(0)-BL(R) and the complement bit lines BLB(0)-BLB(R). In this manner, the PUF response memory array 514 can output different PUF response output data words 524(0)-524(R) based on how different PUF challenge input data words 516(0)-516(N) as memory addresses (e.g., different “challenges”) cause the first and second PUF challenge memory arrays 512(1), 512(2) to generate the first and second intermediate PUF challenge output data words 520(1)(0)-520(1)(N), 520(2)(0)-520(2)(P). For example, as shown in FIG. 6A, the memory states of the challenge memory bit cells 600(1)(0)(0)-600(1)(M)(N), 600(2)(0)(0)-600(2)(M)(P) generated by the first and second PUF challenge memory arrays 512(1), 512(2) may be stored in a respective first and second intermediate challenge output registers 636(1), 636(2). The memory states of the response memory bit cells 602(0)(0)-602(Q)(R) generated by the PUF response memory array 514 may be stored in a PUF response output register 638 that is coupled to the PUF response output 526.

FIG. 6B illustrates an example of a memory bit cell 616 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 502 in FIG. 6A. In this example, the memory bit cell 616 is an SRAM bit cell 618. The SRAM bit cell 618 is a 6-T static complement memory bit cell in this example. The SRAM bit cell 618 includes cross-coupled first and second inverters 620(1), 620(2) powered by a positive supply voltage V_{DD} on a positive supply voltage rail 622P. The first and second inverters 620(1), 620(2) reinforce each other to retain data in the form of a voltage on a respective true storage output 624T and a complement storage output 624C. The first and second inverters 620(1), 620(2) are each comprised of a respective pull-up PFET 626P(1), 626P(2) coupled to a respective pull-down NFET 626N(1), 626N(2). The pull-up PFETs 626P(1), 626P(2) are coupled to the positive supply voltage rail 622P configured to receive the positive supply voltage V_{DD}. The pull-down NFETs 626N(1), 626N(2) are coupled to a supply voltage rail 622N configured to receive a ground voltage or negative supply voltage V_{SS}. First and second NFET access transistors 628(1), 628(2) are coupled to the respective first and second inverters 620(1), 620(2) to provide read and write access to the SRAM bit cell 618. The first and second NFET access transistors 628(1), 628(2) are coupled to a respective bit line BL and complement bit line (BLB), which may be a bit line BL and a complement bit line BLB in the first PUF challenge memory array 512(1) as either the first or second challenge memory bit cell column inputs 536(1), 536(2) in the first or second PUF challenge memory array 512(1), 512(2), or a bit line BL and complement bit line BLB in the PUF response memory array 514 as a response memory bit cell column input 548 in the PUF memory 502 in FIG. 6A.

In a read operation to the SRAM bit cell 618, the bit lines BL and complement bit lines BLB are pre-charged to the positive supply voltage V_{DD} or half the positive supply voltage V_{DD}/2, as examples. Then, a word line WL coupled to gates G of the first and second NFET access transistors 628(1), 628(2) is asserted to evaluate the differential voltages on the true storage output 624T and complement storage output 624C to read the SRAM bit cell 618. The word line WL can be the challenge memory bit cell selection input 530 for the PUF challenge memory 504 and the response memory bit cell selection input 542 for the PUF response memory 506. The word line WL is configured to carry the challenge memory selection signal 532 for the PUF challenge memory 504 and the response memory selection signal 544 for the PUF response memory 506. If a logic high voltage level (i.e., a ‘1’) is stored at the true storage output 624T, a logic low voltage level (i.e., ‘0’) is stored at the complement storage output 624C. If a logic low voltage level (i.e., a ‘0’) is stored at the true storage output 624T, a logic high voltage level (i.e., ‘1’) is stored at the complement storage output 624C. Assertion of the word line WL will cause the NFET access transistors 628(1), 628(2) to discharge the pre-charged voltage on the bit line BL or complement bit line BLB to the respective true or complement storage outputs 624T, 624C and through the respective NFET access transistors 628(1), 628(2) to the supply voltage rail 622N. A read enable control circuit 630 in the form of an NFET 632 in this example is coupled between drains D of the NFET access transistors 628(1), 628(2) and the supply voltage rail 622N to control when the SRAM bit cell 618 is activated. A gate G of the NFET 632 is configured to receive a read enable signal Readen on a read enable input 634.

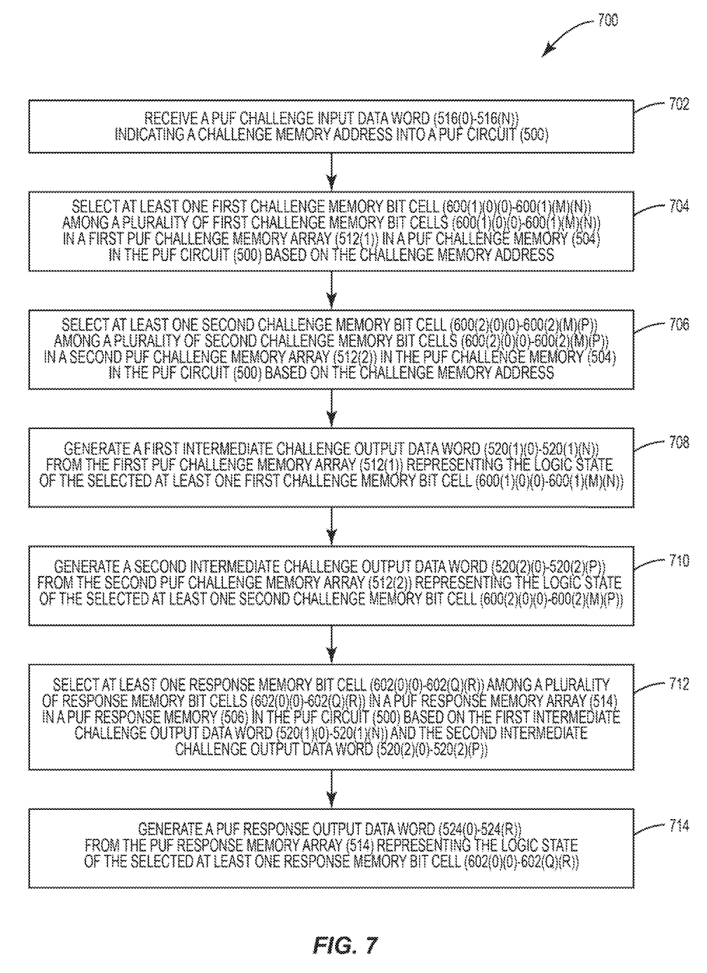

FIG. 7 is a flowchart illustrating an exemplary process 700 that can be performed by a PUF circuit, including the PUF circuit 500 in FIG. 5 or 6A, wherein the first and second intermediate PUF challenge output data words 520(1)(0)-520(1)(N), 520(2)(0)-520(2)(P) from the PUF challenge memory 504 generated in response to the PUF challenge input data word 516(0)-516(N) are input into a PUF response memory 506 to generate the PUF response output data word 524(0)-524(R). The process 700 in FIG. 7 will be discussed in regard to the PUF circuit 500 in FIGS. 5 and 6A.

In this regard, the process 700 includes receiving a PUF challenge input data word 516(0)-516(N) indicating a challenge memory address into a PUF circuit 500 (block 702). The process 700 also includes selecting at least one first challenge memory bit cell 600(1)(0)(0)-600(1)(M)(N) among a plurality of first challenge memory bit cells 600(1)(0)(0)-600(1)(M)(N) in a first PUF challenge memory array 512(1) in a PUF challenge memory 504 in the PUF circuit 500 based on the challenge memory address (block 704). The process 700 also includes selecting at least one second challenge memory bit cell 600(2)(0)(0)-600(2)(M)(P) among a plurality of second challenge memory bit cells 600(2)(0)(0)-600(2)(M)(P) in a second PUF challenge memory array 512(2) in the PUF challenge memory 504 in the PUF circuit 500 based on the challenge memory address (block 706). The process 700 also includes generating a first intermediate PUF challenge output data word 520(1)(0)-520(1)(N) from the first PUF challenge memory array 512(1) representing the logic state of the selected at least one first challenge memory bit cell 600(1)(0)(0)-600(1)(M)(N) (block 708). The process 700 also includes generating a second intermediate PUF challenge output data word 520(2)(0)-520(2)(P) from the second PUF challenge memory array 512(2) representing the logic state of the selected at least one second challenge memory bit cell 600(2)(0)(0)-600(2)(M)(P) (block 710). The process 700 also includes selecting at least one response memory bit cell 602(0)(0)-602(Q)(R) among a plurality of response memory bit cells 602(0)(0)-602(Q)(R) in a PUF response memory array 514 in a PUF response memory 506 in the PUF circuit 500 based on the first intermediate PUF challenge output data word 520(1)(0)-520(1)(N) and the second intermediate PUF challenge output data word 520(2)(0)-520(2)(P) (block 712). The process 700 also includes generating a PUF response output data word 524(0)-524(R) from the PUF response memory array 514 representing the logic state of the selected at least one response memory bit cell 602(0)(0)-602(Q)(R) (block 714).

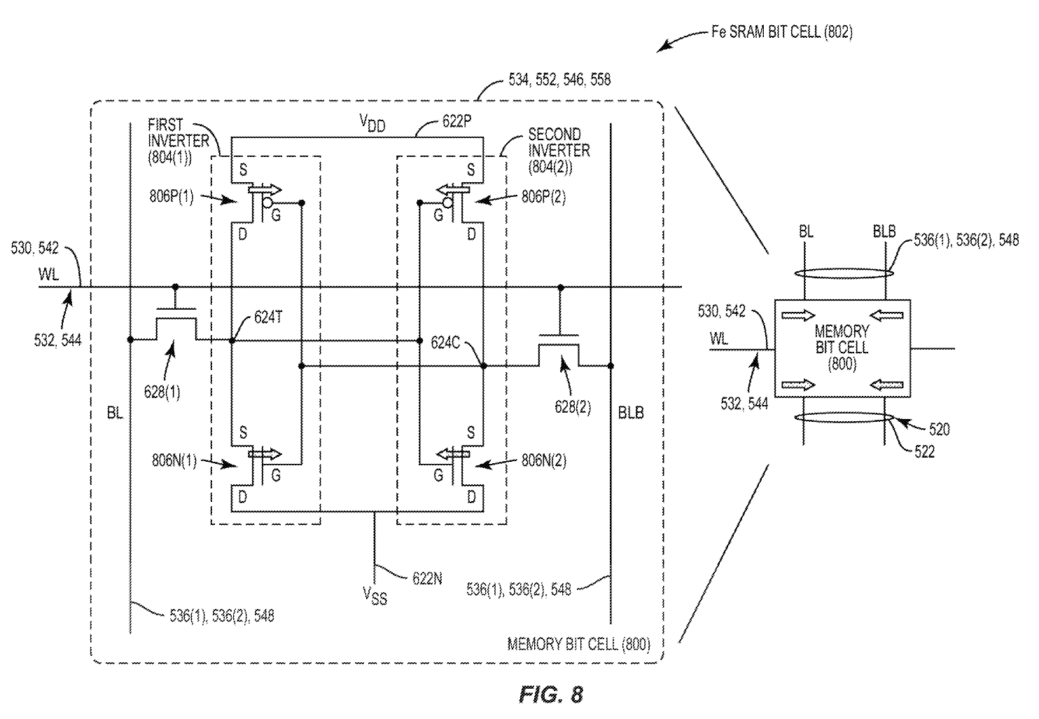

Other types of memory bit cells other than the SRAM bit cell 618 in FIG. 6B can be used as the first challenge memory bit cells 600(1)(0)(0)-600(1)(M)(N), the second challenge memory bit cells 600(2)(0)(0)-600(2)(M)(P), and/or the response memory bit cells 602(0)(0)-602(Q)(R) in the PUF circuit 500 in FIG. 6A. For example, FIG. 8 illustrates an example of a memory bit cell 800 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 502 in FIG. 6A. In this example, the memory bit cell 800 is a ferroelectric (Fe) SRAM bit cell 802. The Fe SRAM bit cell 802 is a 6-T static complement memory bit cell in this example. Common elements between the SRAM bit cell 618 in FIG. 6B and the Fe SRAM bit cell 802 in FIG. 8 are shown with common element numbers and thus will not be re-described. The Fe SRAM bit cell 802 includes cross-coupled first and second inverters 804(1), 804(2) powered by a positive supply voltage V_{DD} on a positive supply voltage rail 622P. The first and second inverters 804(1), 804(2) are each comprised of respective pull-up Fe PFETs 806P(1), 806P(2) coupled to respective pull-down Fe NFETs 806N(1), 806N(2).

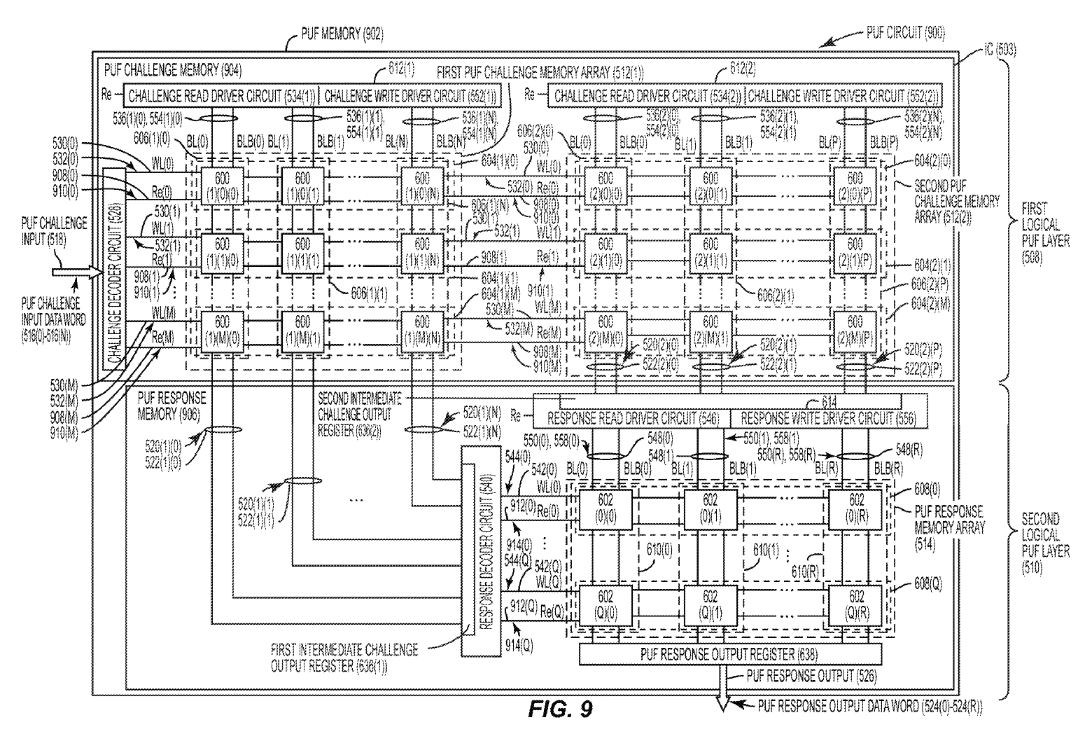

FIG. 9 is a schematic diagram of another exemplary PUF circuit 900 in the form of a PUF memory 902 that is similar to the PUF circuit 500 in FIG. 6A. However, in the PUF circuit 900 in FIG. 9, a PUF challenge memory 904 and a PUF response memory 906 are configured to include read enable inputs that control whether the PUF challenge memory 904 and the PUF response memory 906 are activated, such as in response to a PUF read operation. In this regard, common elements between the PUF circuit 900 in FIG. 9 and the PUF circuit 500 in FIG. 6A are shown with common element numbers in FIG. 9 and thus will not be re-described.

As shown in FIG. 9, the PUF challenge memory 904 includes challenge read enable inputs (Re(0)-Re(M)) 908(0)-908(M) coupled to the plurality of first challenge memory bit cells 600(1)(0)(0)-600(1)(M)(N) in a respective challenge memory bit cell row circuit 604(1)(0)-604(1)(M), 604(2)(0)-604(2)(M). The PUF response memory 506 includes response read enable inputs (Re(0)-Re(Q)) 912(0)-912(Q) coupled to the plurality of response memory bit cells 602(0)(0)-602(Q)(R). The first PUF challenge memory array 512(1) is configured to generate the first intermediate PUF challenge output data word 520(1)(0)-520(1)(N) on the first intermediate PUF challenge output 522(1)(0)-522(1)(M) representing a logic state stored in a selected challenge memory bit cell row circuit 604(1)(0)-604(1)(M), based on the challenge memory selection signal 532 on the challenge memory bit cell selection input 530 and a read enable signal 910(0)-910(M) being in a read enable state on the challenge read enable inputs (Re(0)-Re(M)) 908(0)-908(M). In the PUF circuit 900 in FIG. 9, the challenge read enable inputs (Re(0)-Re(M)) 908(0)-908(M) are active high inputs. The second PUF challenge memory array 512(2) is also configured to generate the second intermediate PUF challenge output data word 520(2)(0)-520(2)(N) on the second intermediate PUF challenge outputs 522(2)(0)-522(2)(P) representing a logic state stored in a selected challenge memory bit cell row circuit 604(2)(0)-604(2)(M), based on the challenge memory selection signal 532 on the challenge memory bit cell selection input 530 and a read enable signal 910(0)-910(M) being in a read enable state on the challenge read enable inputs (Re(0)-Re(M)) 908(0)-908(M). Similarly, the PUF response memory array 514 is configured to generate the PUF response output data word 524(0)-524(R) on the PUF response outputs 526(0) representing a logic state stored in a selected response memory bit cell row circuit 608(0)-608(Q), based on the response memory selection signal 544 on the response memory bit cell selection inputs 542(0)-542(Q) and a read enable signal 914(0)-914(Q) being in a read enable state on the response read enable inputs (Re(0)-Re(Q)) 912(0)-912(Q). In the PUF circuit 900 in FIG. 9, the response read enable inputs (Re(0)-Re(Q)) 912(0)-912(Q) are active high inputs.

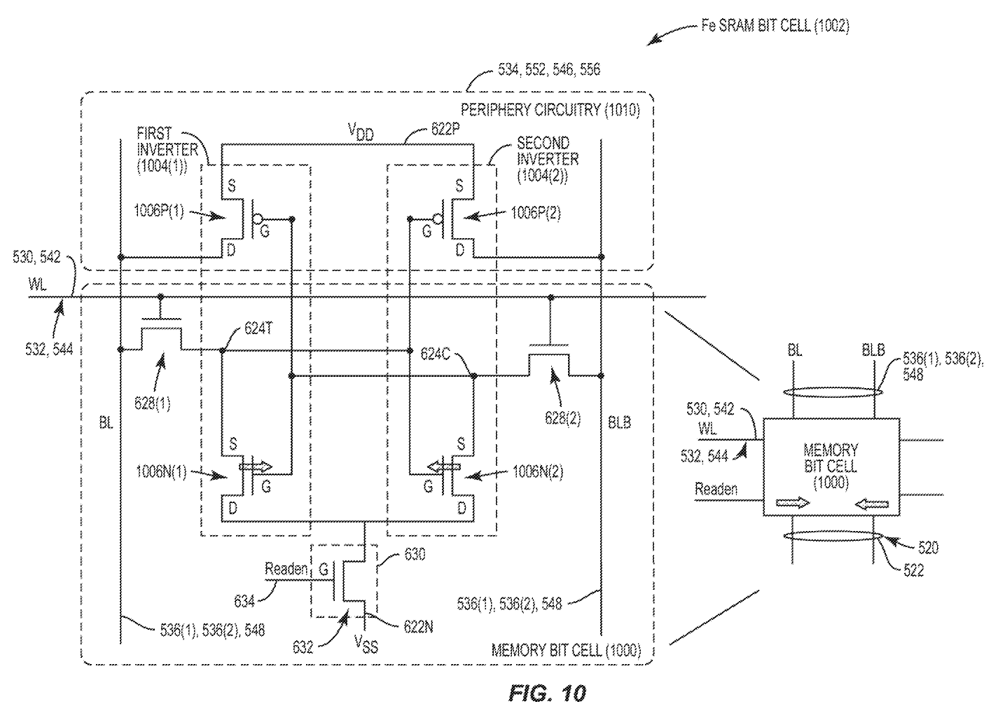

FIG. 10 illustrates an example of a memory bit cell 1000 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 902 in FIG. 9. In this example, the memory bit cell 1000 is a ferroelectric (Fe) SRAM bit cell 1002. The Fe SRAM bit cell 1002 is a 6-T static complement memory bit cell in this example. Common elements between the Fe SRAM bit cell 802 in FIG. 8 and the Fe SRAM bit cell 1002 in FIG. 10 are shown with common element numbers and thus will not be re-described. The Fe SRAM bit cell 1002 includes cross-coupled first and second inverters 1004(1), 1004(2) powered by a positive supply voltage V_{DD} on a positive supply voltage rail 622P. The first and second inverters 1004(1), 1004(2) are each comprised of respective pull-up PFETs 1006P(1), 1006P(2) coupled to respective pull-down NFETs 1006N(1), 1006N(2). Note that the pull-up PFETs 1006P(1), 1006P(2) can be provided in a periphery circuitry 1010, that may be included in the challenge and/or response read driver circuits 534(1), 534(2), 546, the challenge and/or write driver circuits 552(1), 552(2), 556, and/or challenge and/or response challenge column decoder circuits 612(1), 612(2), 614.

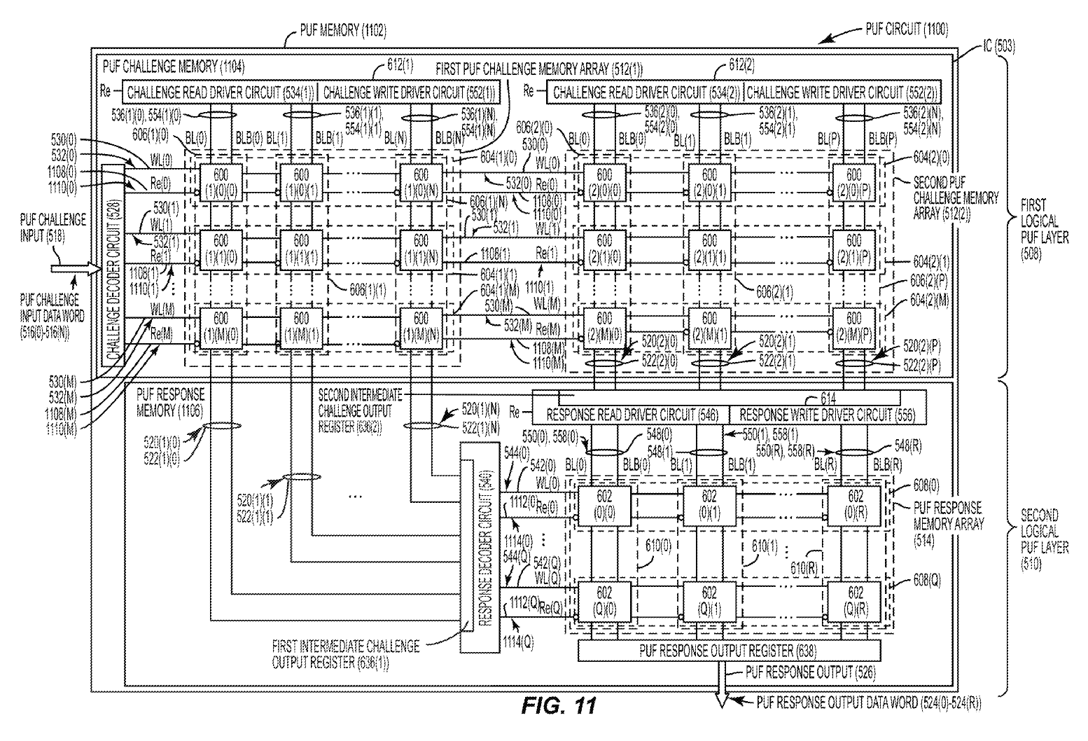

FIG. 11 is a schematic diagram of another exemplary PUF circuit 1100 in the form of a PUF memory 1102 that is similar to the PUF circuit 900 in FIG. 9. However, in the PUF circuit 1100 in FIG. 11, a PUF challenge memory 1104 and PUF response memory 1106 are configured with active low read enable inputs that control whether the PUF challenge memory 1104 and PUF response memory 1006 are activated, such as in response to a PUF read operation. In this regard, common elements between the PUF circuit 1100 in FIG. 11 and the PUF circuit 900 in FIG. 9 are shown with common element numbers in FIG. 11 and thus will not be re-described.

As shown in FIG. 11, the PUF challenge memory 1104 includes active low challenge read enable inputs (Re(0)-Re(M)) 1108(0)-1108(M) coupled to the plurality of first challenge memory bit cells 600(1)(0)(0)-600(1)(M)(N) in a respective challenge memory bit cell row circuit 604(1)(0)-604(1)(M), 604(2)(0)-604(2)(M). The PUF response memory 1106 includes active low response read enable inputs (Re(0)-Re(Q)) 1112(0)-1112(Q) coupled to the plurality of response memory bit cells 602(0)(0)-602(Q)(R). The PUF challenge memory array 512(1) is configured to generate the first intermediate PUF challenge output data word 520(1)(0)-520(1)(N) on the first intermediate PUF challenge output 522(1)(0)-522(1)(M) representing a logic state stored for a selected challenge memory bit cell 600(1)(0)(0)-600(1)(M)(N) in a selected challenge memory bit cell row circuit 604(1)(0)-604(1)(M), based on the challenge memory selection signal 532 on the challenge memory bit cell selection input 530 and a read enable signal 1110(0)-1110(M) being in a read enable state on the first challenge read enable inputs (Re(0)-Re(M)) 1108(0)-1108(M). In the PUF circuit 1100 in FIG. 11, the first challenge read enable inputs (Re(0)-Re(M)) 1108(0)-1108(M) are active low inputs. The second PUF challenge memory array 512(2) is also configured to generate the second intermediate PUF challenge output data word 520(2)(0)-520(2)(N) on the second intermediate PUF challenge outputs 522(2)(0)-522(2)(M) representing a logic state stored for a selected challenge memory bit cell 600(2)(0)(0)-600(2)(M)(P) in a selected challenge memory bit cell row circuit 604(2)(0)-604(2)(M), based on the challenge memory selection signal 532 on the challenge memory bit cell selection input 530 and a read enable signal 1110(0)-1110(M) being in a read enable state on the challenge read enable inputs (Re(0)-Re(M)) 1108(0)-1108(M). Similarly, the PUF response memory array 514 is configured to generate the PUF response output data word 524(0)-524(R) on the PUF response outputs 526 representing a logic state stored for a selected response memory bit cells 602(0)(0)-602(Q)(R) in a selected response memory bit cell row circuit 608(0)-608(Q), based on the response memory selection signal 544 on the response memory bit cell selection inputs 542(0)-542(Q) and a read enable signal 1114(0)-1114(Q) being in a read enable state on the first challenge read enable inputs (Re(0)-Re(Q)) 1112(0)-1112(Q).

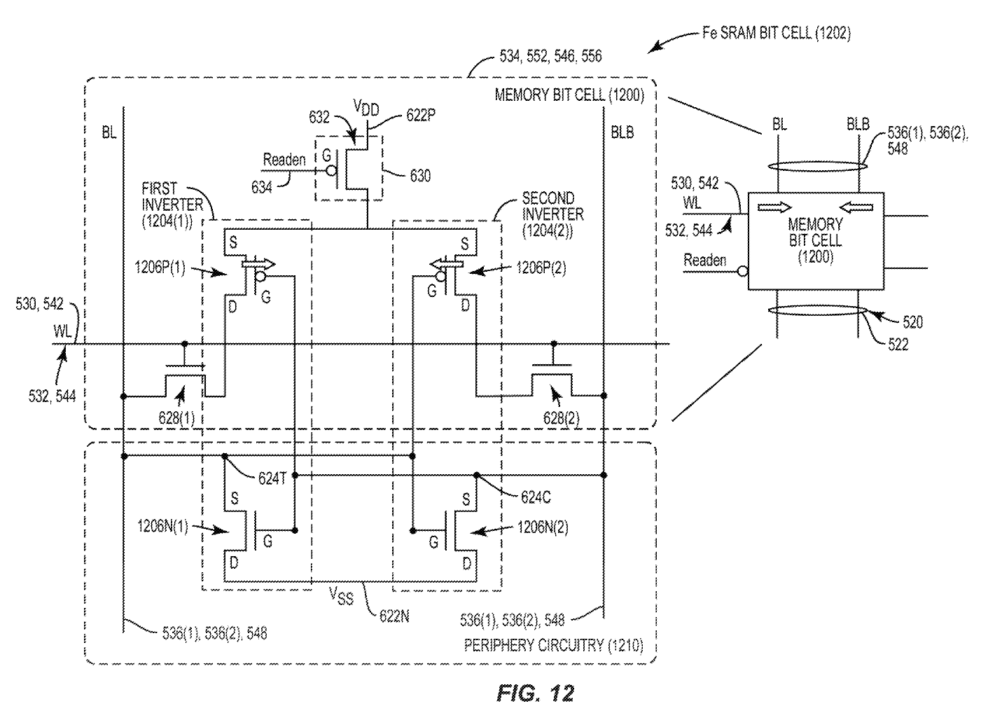

FIG. 12 illustrates an example of a memory bit cell 1200 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1102 in FIG. 11. In this example, the memory bit cell 1200 is a ferroelectric (Fe) SRAM bit cell 1202. The Fe SRAM bit cell 1202 is a 6-T static complement memory bit cell in this example. Common elements between the Fe SRAM bit cell 1002 in FIG. 10 and the Fe SRAM bit cell 1202 in FIG. 12 are shown with common element numbers and thus will not be re-described. The Fe SRAM bit cell 1202 includes cross-coupled first and second inverters 1204(1), 1204(2) powered by a positive supply voltage V_{DD} on a positive supply voltage rail 622P. The first and second inverters 1204(1), 1204(2) are each comprised of respective pull-up Fe PFETs 1206P(1), 1206P(2) coupled to respective pull-down Fe NFETs 1206N(1), 1206N(2). Note that the pull-down Fe NFETs 1206N(1), 1206N(2) can be provided in a periphery circuitry 1210, that may be included in the challenge and/or response read driver circuits 534(1), 534(2), 546, the challenge and/or write driver circuits 552(1), 552(2), 556, and/or challenge and/or response challenge column decoder circuits 612(1), 612(2), 614.

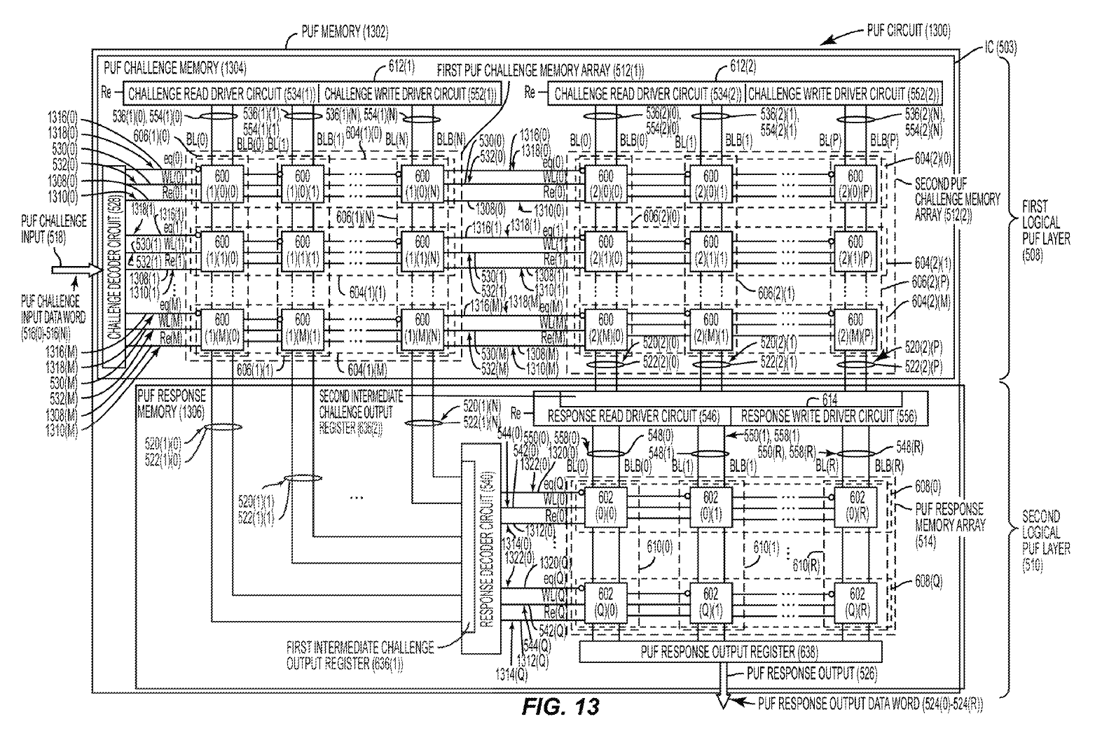

FIG. 13 is a schematic diagram of another exemplary PUF circuit 1300 in the form of a PUF memory 1302 that is similar to the PUF circuit 1100 in FIG. 11. However, in the PUF circuit 1300 in FIG. 13, a PUF challenge memory 1304 and PUF response memory 1306 are additionally configured with equalization inputs for controlling an internal pre-charge operation mode. In the PUF circuit 1300 in FIG. 13, the PUF challenge memory 1304 and the PUF response memory 1306 are also configured with active low read enable inputs included in the PUF circuit 1100 in FIG. 11 for controlling a read operation mode. In this regard, common elements between the PUF circuit 1300 in FIG. 13 and the PUF circuit 1100 in FIG. 11 are shown with common element numbers in FIG. 13 and thus will not be re-described.

As shown in FIG. 13, the PUF challenge memory 1304 includes active low challenge read enable inputs (Re(0)-Re(M)) 1308(0)-1308(M) coupled to the plurality of first challenge memory bit cells 600(1)(0)(0)-600(1)(M)(N) in a respective challenge memory bit cell row circuit 604(1)(0)-604(1)(M), 604(2)(0)-604(2)(M). The PUF response memory 1306 includes active low response read enable inputs (Re(0)-Re(Q)) 1312(0)-1312(Q) coupled to the plurality of response memory bit cells 602(0)(0)-602(Q)(R). The first PUF challenge memory array 512(1) is configured to generate the first intermediate PUF challenge output data word 520(1)(0)-520(1)(N) on the first intermediate PUF challenge output 522(1)(0)-522(1)(M) representing a logic state stored for a selected challenge memory bit cells 600(1)(0)(0)-600(1)(M)(N) in a selected challenge memory bit cell row circuit 604(1)(0)-604(1)(M), based on the challenge memory selection signal 532 on the challenge memory bit cell selection input 530 and a read enable signal 1310(0)-1310(M) being in a read enable state on the first challenge read enable inputs (Re(0)-Re(M)) 1308(0)-1308(M). In the PUF circuit 1300 in FIG. 13, the first challenge read enable inputs (Re(0)-Re(M)) 1308(0)-1308(M) are active low inputs. The second PUF challenge memory array 512(2) is also configured to generate the second intermediate PUF challenge output data word 520(2)(0)-520(2)(N) on the second intermediate PUF challenge outputs 522(2)(0)-522(2)(M) representing a logic state stored for a selected challenge memory bit cell 600(2)(0)(0)-600(2)(M)(P) in a selected challenge memory bit cell row circuit 604(2)(0)-604(2)(M), based on the challenge memory selection signal 532 on the challenge memory bit cell selection input 530 and a read enable signal 1310(0)-1310(M) being in a read enable state on the challenge read enable inputs (Re(0)-Re(M)) 1308(0)-1308(M). Similarly, the PUF response memory array 514 is configured to generate the PUF response output data word 524(0)-524(R) on the PUF response outputs 526 representing a logic state stored selected response memory bit cells 602(0)(0)-602(Q)(R) in a selected response memory bit cell row circuit 608(0)-608(Q), based on the response memory selection signal 544 on the response memory bit cell selection inputs 542(0)-542(Q) and a read enable signal 1314(0)-1314(Q) being in a read enable state on the first response read enable inputs (Re(0)-Re(Q)) 1312(0)-1312(Q).

With continuing reference to FIG. 13, the PUF challenge memory 1304 includes challenge equalization enable inputs (eq(0)-eq(M)) 1316(0)-1316(M) coupled to the plurality of first challenge memory bit cells 600(1)(0)(0)-600(1)(M)(N) and the plurality of second challenge memory bit cells 600(2)(0)(0)-600(2)(M)(P) in a respective challenge memory bit cell row circuit 604(1)(0)-604(1)(M), 604(2)(0)-604(2)(M). The challenge equalization enable inputs (eq(0)-eq(M)) 1316(0)-1316(M) are configured to receive respective challenge equalization enable signals 1318(0)-1318(M). The PUF response memory 1306 includes response equalization enable inputs (eq(0)-eq(Q)) 1320(0)-1320(Q) coupled to the plurality of response memory bit cells 602(0)(0)-602(Q)(R). The response equalization enable inputs (eq(0)-eq(Q)) 1320(0)-1320(Q) are configured to receive respective response equalization enable signals 1322(0)-1322(Q). As will be discussed in more detail below, the challenge equalization enable signals 1318(0)-1318(M) are configured to be coupled to an equalization circuit in the first challenge memory bit cells 600(1)(0)(0)-600(1)(M)(N) and the second challenge memory bit cells 600(2)(0)(0)-600(2)(M)(P). The first challenge memory bit cells 600(1)(0)(0)-600(1)(M)(N) and the second challenge memory bit cells 600(2)(0)(0)-600(2)(M)(P) are configured to equalize the respective first intermediate PUF challenge output 522(1)(0)-522(1)(M) and the second intermediate PUF challenge outputs 522(2)(0)-522(2)(M) in response to the challenge equalization enable signals 1318(0)-1318(M) indicating an equalization enable state. Equalizing the respective first intermediate PUF challenge output 522(1)(0)-522(1)(M) and the second intermediate PUF challenge output 522(2)(0)-522(2)(M) can be performed in a pre-charge operation before the first challenge memory bit cells 600(1)(0)(0)-600(1)(M)(N) and the second challenge memory bit cells 600(2)(0)(0)-600(2)(M)(P) resolve a memory state on the first intermediate PUF challenge output 522(1)(0)-522(1)(M) and the second intermediate PUF challenge output 522(2)(0)-522(2)(M). Similarly, the response memory bit cells 602(0)(0)-602(Q)(R) are configured to equalize the respective PUF response output 526 in response to the response equalization enable signals 1322(0)-1322(Q) indicating an equalization enable state. Equalizing the respective PUF response output 526 can be performed in a pre-charge operation before the response memory bit cells 602(0)(0)-602(Q)(R) resolve a memory state on the PUF response output 526.

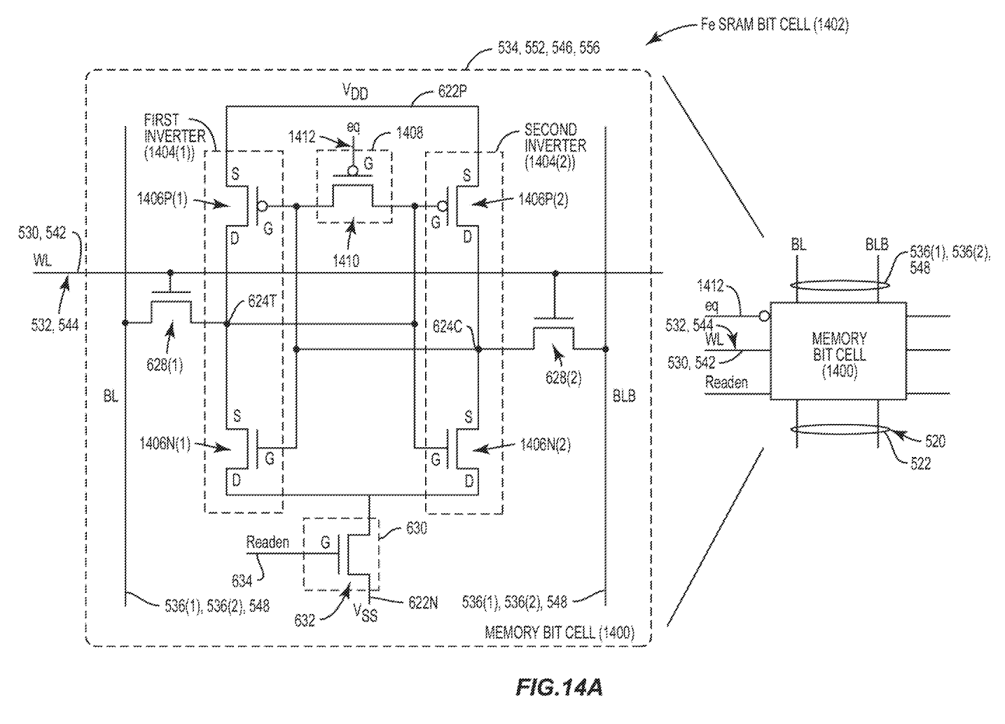

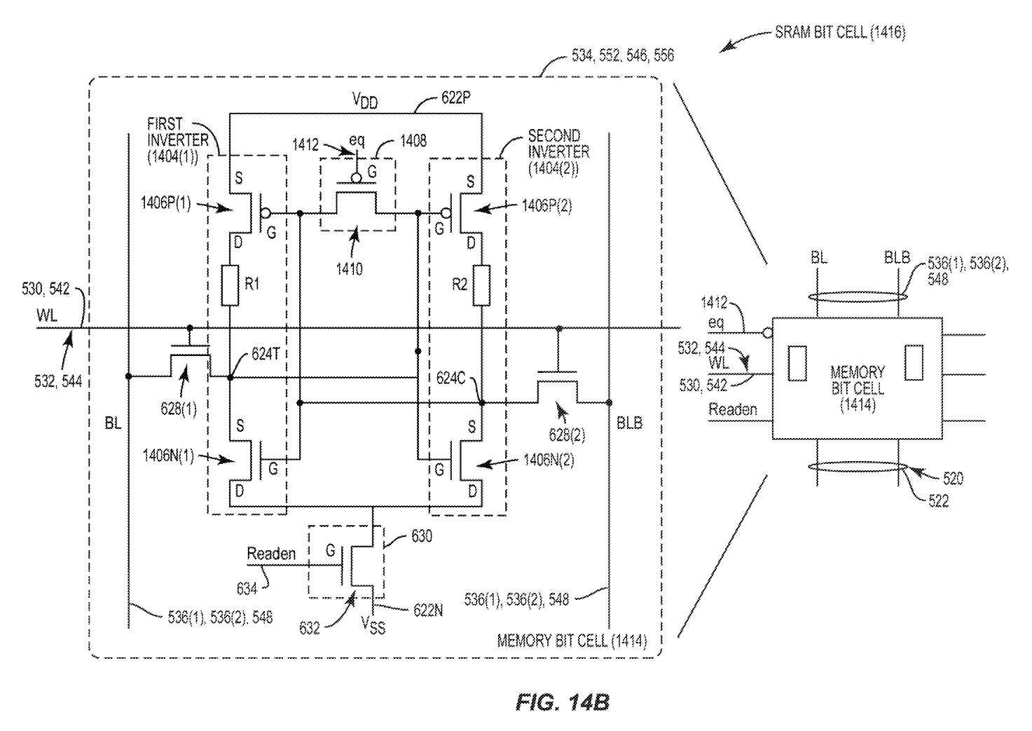

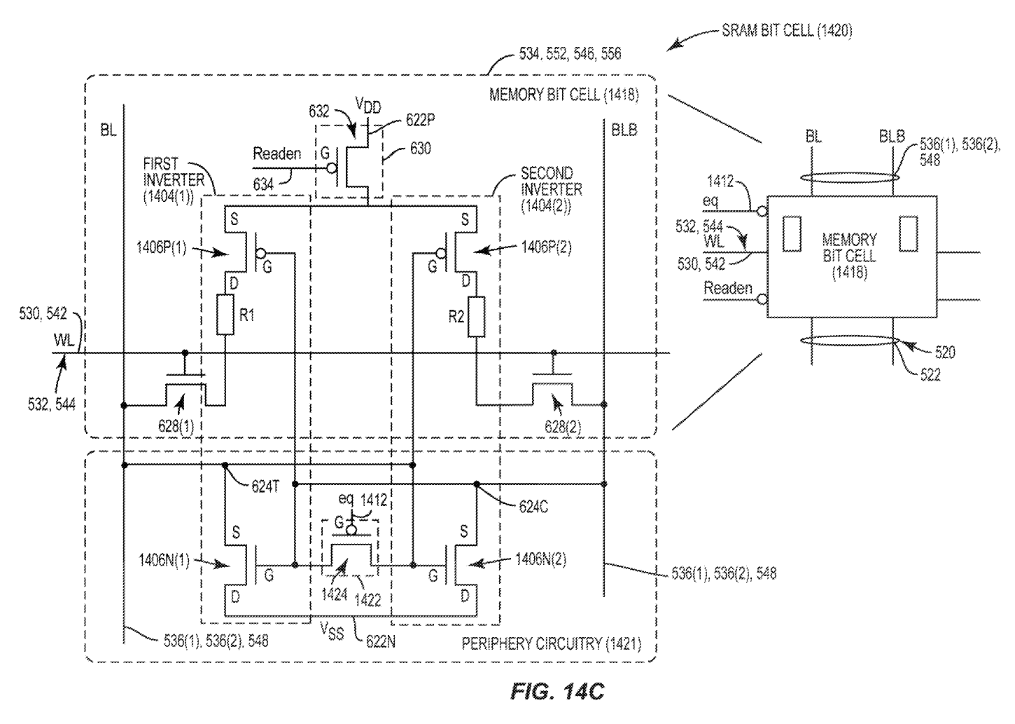

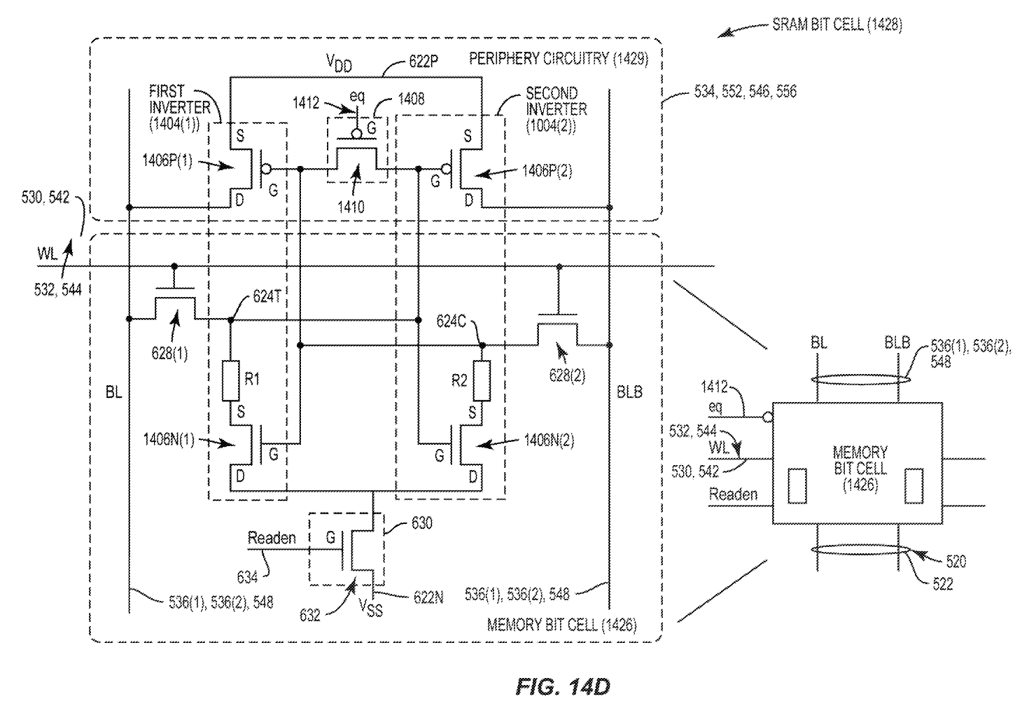

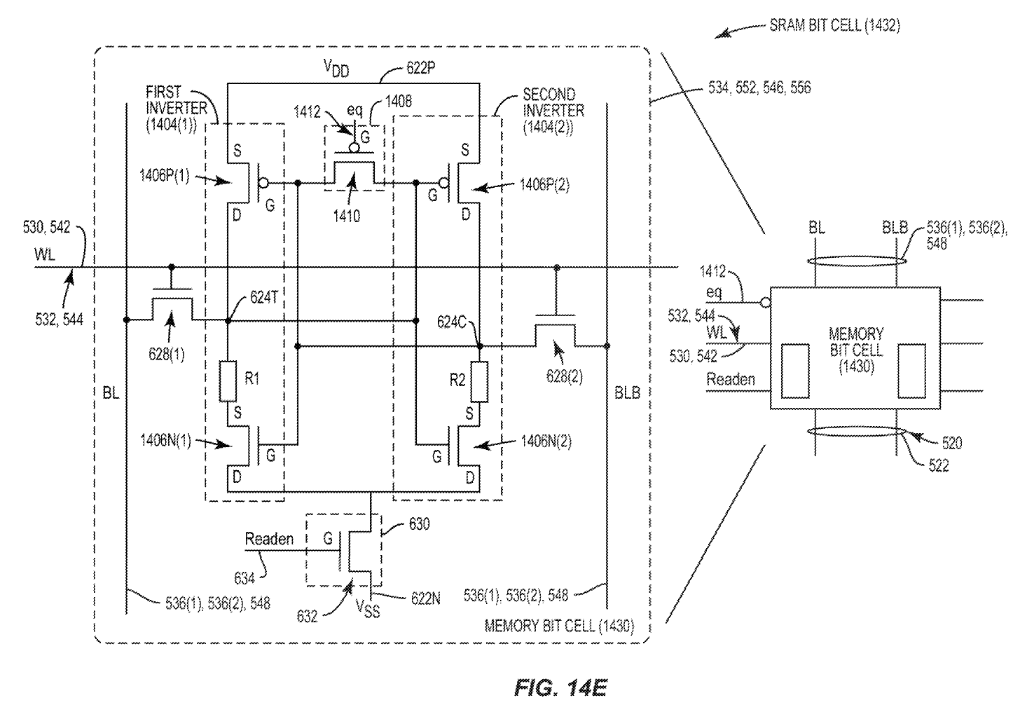

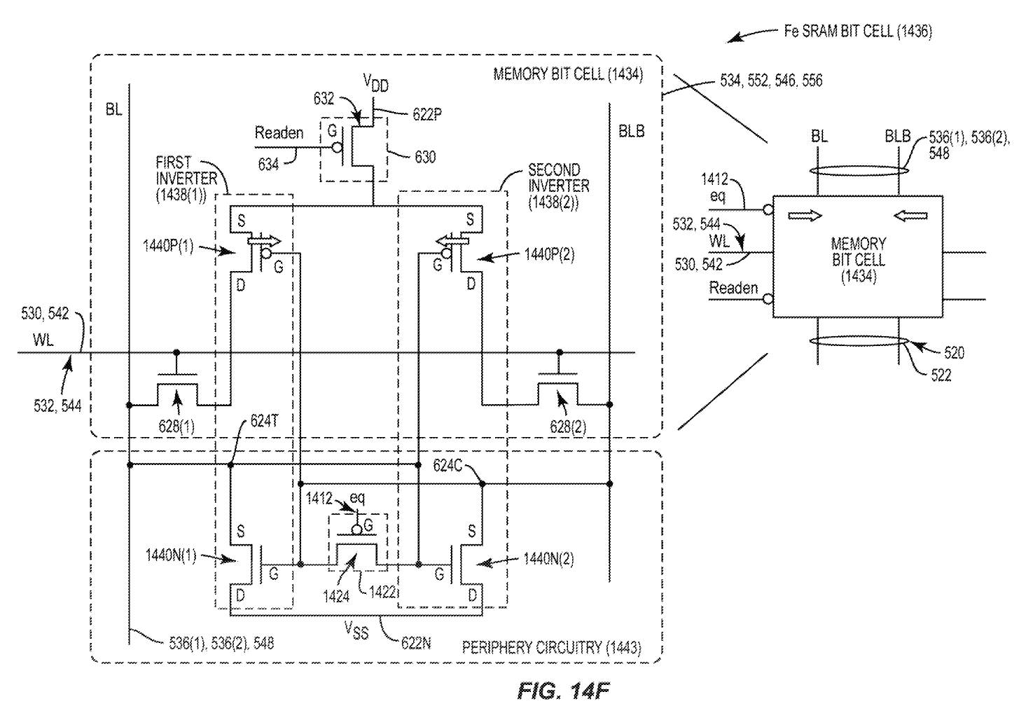

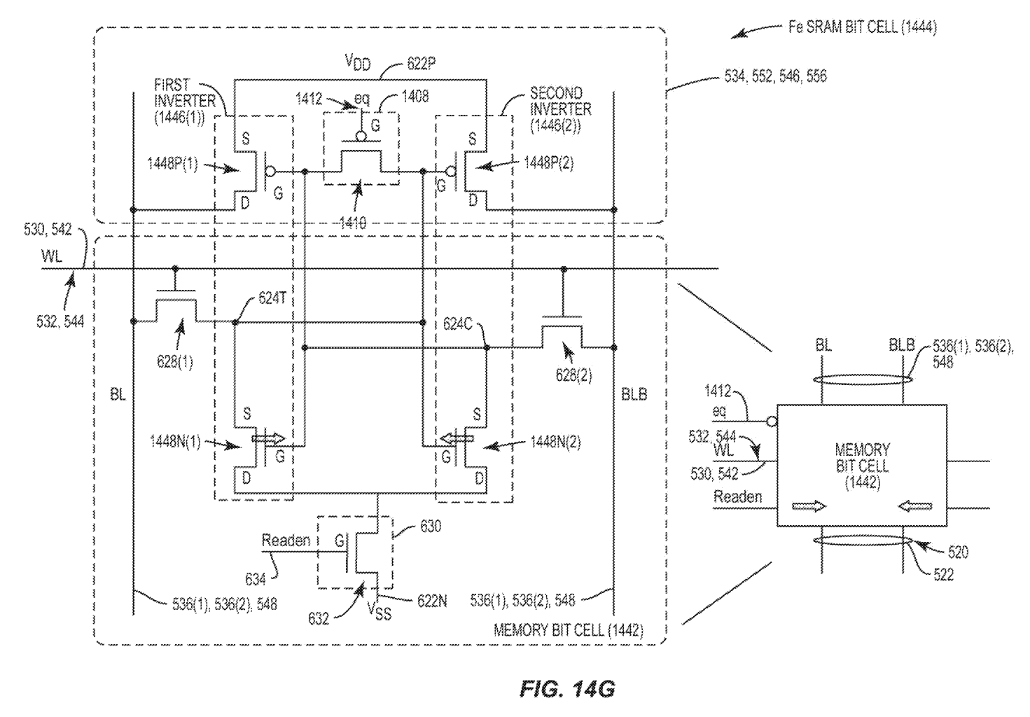

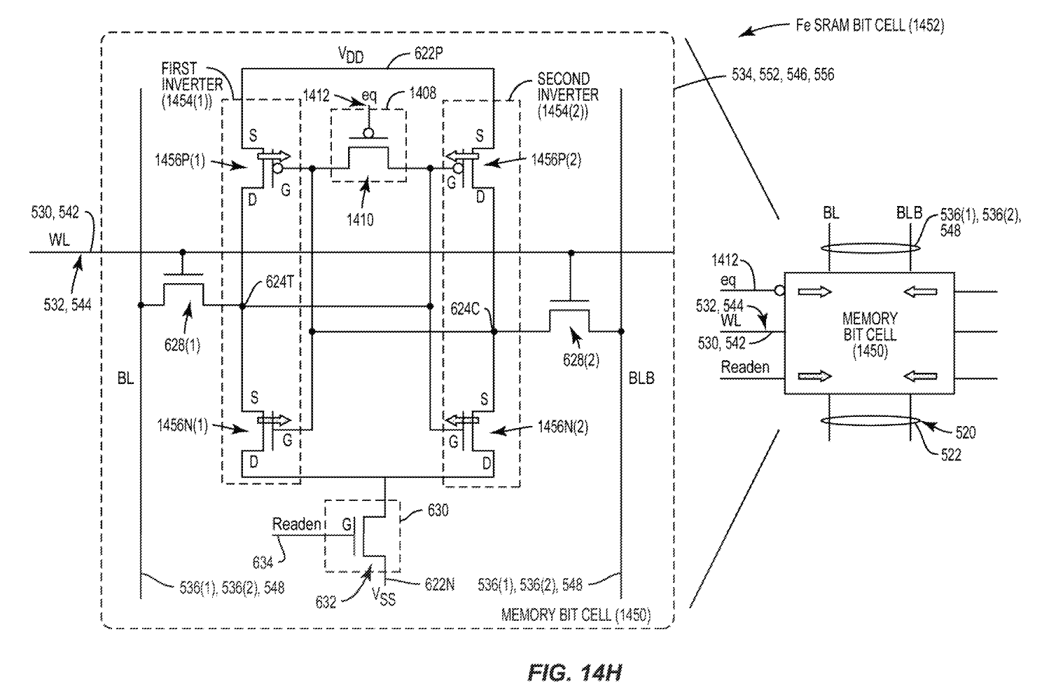

FIG. 14A illustrates an example of a memory bit cell 1400 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1302 in FIG. 13. In this example, the memory bit cell 1400 is an SRAM bit cell 1402. The SRAM bit cell 1402 is a 6-T static complement memory bit cell in this example. Common elements between the Fe SRAM bit cell 1202 in FIG. 12 and the SRAM bit cell 1402 in FIG. 14 are shown with common element numbers and thus will not be re-described. The SRAM bit cell 1402 includes cross-coupled first and second inverters 1404(1), 1404(2) powered by a positive supply voltage V_{DD} on a positive supply voltage rail 622P. The first and second inverters 1404(1), 1404(2) are each comprised of respective pull-up PFETs 1406P(1), 1406P(2) coupled to respective pull-down NFETs 1406N(1), 1406N(2). The SRAM bit cell 1402 includes an equalization circuit 1408 that is a PFET 1410 in this example. A gate G of the PFET 1410 is coupled to an equalization enable input eq, which may be the challenge equalization enable inputs (eq(0)-eq(M)) 1316(0)-1316(M) or the response equalization enable inputs (eq(0)-eq(Q)) 1320(0)-1320(Q) as discussed above. The PFET 1410 is coupled to gates G of the pull-up PFETs 1406P(1), 1406P(2) to couple together and equalize the true storage output 624T and the complement storage output 624C in response to an equalization signal 1412 being a low logic level.

FIG. 14B illustrates another example of a memory bit cell 1414 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1302 in FIG. 13. In this example, the memory bit cell 1414 is an SRAM bit cell 1416. The SRAM bit cell 1416 is a 6-T static complement memory bit cell in this example. Common elements between the SRAM bit cell 1402 in FIG. 14A and the SRAM bit cell 1416 in FIG. 14B are shown with common element numbers and thus will not be re-described.

FIG. 14C illustrates another example of a memory bit cell 1418 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1302 in FIG. 13. In this example, the memory bit cell 1418 is an SRAM bit cell 1420. The SRAM bit cell 1420 is a 6-T static complement memory bit cell in this example. Common elements between the SRAM bit cell 1402 in FIG. 14A and the SRAM bit cell 1420 in FIG. 14C are shown with common element numbers and thus will not be re-described. The SRAM bit cell 1420 includes an equalization circuit 1422 that is a PFET 1424 in this example. A gate G of the PFET 1424 is coupled to an equalization enable input eq, which may be the challenge equalization enable inputs (eq(0)-eq(M)) or the response equalization enable inputs (eq(0)-eq(Q)) as discussed above. The PFET 1424 is coupled to gates G of the pull-down NFETs 1406N(1), 1406N(2) to couple together and equalize the true storage output 624T and the complement storage output 624C in response to the equalization signal 1412 being a low logic level. Note that the PFET 1424 can be provided in a periphery circuitry 1421, that may be included in the challenge and/or response read driver circuits 534(1), 534(2), 546, the challenge and/or write driver circuits 552(1), 552(2), 556, and/or challenge and/or response challenge column decoder circuits 612(1), 612(2), 614.

FIG. 14D illustrates another example of a memory bit cell 1426 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1302 in FIG. 13. In this example, the memory bit cell 1426 is an SRAM bit cell 1428. The SRAM bit cell 1428 is a 6-T static complement memory bit cell in this example. Common elements between the SRAM bit cell 1402 in FIG. 14A and the SRAM bit cell 1428 in FIG. 14D are shown with common element numbers and thus will not be re-described.

FIG. 14E illustrates another example of a memory bit cell 1430 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1302 in FIG. 13. In this example, the memory bit cell 1426 is an SRAM bit cell 1432. The SRAM bit cell 1428 is a 6-T static complement memory bit cell in this example. Common elements between the SRAM bit cell 1428 in FIG. 14D and the SRAM bit cell 1432 in FIG. 14E are shown with common element numbers and thus will not be re-described.

FIG. 14F illustrates another example of a memory bit cell 1434 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1302 in FIG. 13. In this example, the memory bit cell 1434 is a Fe SRAM bit cell 1436. The SRAM bit cell 1436 is a 6-T static complement memory bit cell in this example. Common elements between the SRAM bit cell 1420 in FIG. 14C and the SRAM bit cell 1436 in FIG. 14F are shown with common element numbers and thus will not be re-described. The Fe SRAM bit cell 1436 includes cross-coupled first and second inverters 1438(1), 1438(2) powered by a positive supply voltage V_{DD} on a positive supply voltage rail 622P. The first and second inverters 14038(1), 1438(2) are each comprised of a respective pull-up Fe PFETs 1440P(1), 1440P(2) coupled to a respective pull-down Fe NFETs 1440N(1), 1440N(2). Note that the pull-up Fe PFETs 1440P(1), 1440P(2) can be provided in a periphery circuitry 1443, that may be included in the challenge and/or response read driver circuits 534(1), 534(2), 546, the challenge and/or write driver circuits 552(1), 552(2), 556, and/or challenge and/or response challenge column decoder circuits 612(1), 612(2), 614.

FIG. 14G illustrates another example of a memory bit cell 1442 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1302 in FIG. 13. In this example, the memory bit cell 1442 is a Fe SRAM bit cell 1444. The Fe SRAM bit cell 1444 is a 6-T static complement memory bit cell in this example. Common elements between the SRAM bit cell 1432 in FIG. 14E and the Fe SRAM bit cell 1444 in FIG. 14G are shown with common element numbers and thus will not be re-described. The Fe SRAM bit cell 1444 includes cross-coupled first and second inverters 1446(1), 1446(2) powered by a positive supply voltage V_{DD} on a positive supply voltage rail 622P. The first and second inverters 1446(1), 1446(2) are each comprised of respective pull-up Fe PFETs 1448P(1), 1448P(2) coupled to respective pull-down Fe NFETs 1448N(1), 1448N(2).

FIG. 14H illustrates another example of a memory bit cell 1450 that can be the challenge memory bit cells 600(1)(0)(0)-600(1)(M)(N), 600(2)(0)(0)-600(2)(M)(P) in the first and second PUF challenge memory arrays 512(1), 512(2) and/or the response memory bit cells 602(0)(0)-602(Q)(R) in the PUF response memory array 514 in the PUF memory 1302 in FIG. 13. In this example, the memory bit cell 1450 is a Fe SRAM bit cell 1452. The Fe SRAM bit cell 1452 is a 6-T static complement memory bit cell in this example. Common elements between the Fe SRAM bit cell 1444 in FIG. 14G and the Fe SRAM bit cell 1452 in FIG. 14H are shown with common element numbers and thus will not be re-described. The Fe SRAM bit cell 1452 includes cross-coupled first and second inverters 1454(1), 1454(2) powered by a positive supply voltage V_{DD} on a positive supply voltage rail 622P. The first and second inverters 1454(1), 1454(2) are each comprised of respective pull-up Fe PFETs 1456P(1), 1456P(2) coupled to respective pull-down Fe NFETs 1456N(1), 1456N(2).

It may be desired to determine the logic state skew of the challenge memory bit cells 600(1)(0)(0)-600(1)(M)(N), 600(2)(0)(0)-600(2)(M)(P) and/or the response memory bit cells 602(0)(0)-602(Q)(R) in the first and second PUF challenge and/or PUF response memory arrays 512(1), 512(2), 514 to determine how to apply stress voltage to the challenge memory bit cells 600(1)(0)(0)-600(1)(M)(N), 600(2)(0)(0)-600(2)(M)(P) and/or the response memory bit cells 602(0)(0)-602(Q)(R) to further enhance their natural skew to enhance reproducibility of the PUF response output data word 524(0)-524(R) from the PUF memory 502 in FIG. 6A.

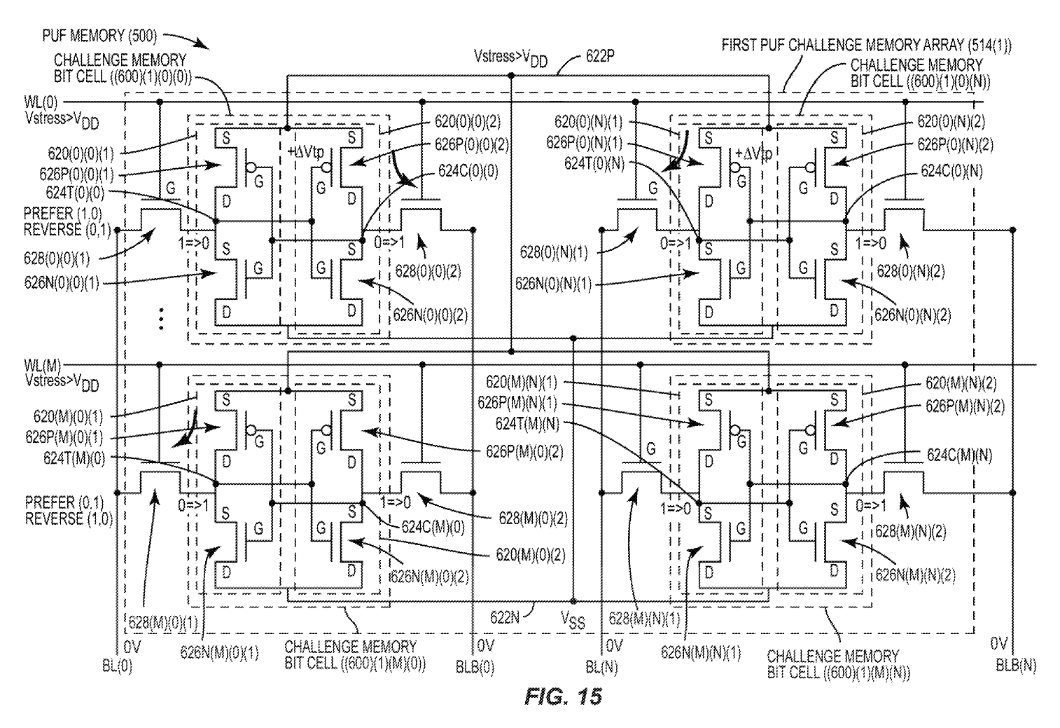

For example, FIG. 15 illustrates an example of stress voltage being applied to pull-up PFETs 626P(0)(0)(1), 626P(0)(0)(2)-626P(M)(N)(1), 626P(M)(N)(2) in inverters 620(0)(0)(1), 620(0)(0)(2), 620(0)(N)(1), 620(0)(N)(2) in the challenge memory bit cells 600(1)(0)(0)-600(1)(M)(N) in the first PUF challenge memory array 512(1) in FIG. 6A as an example identified as being weaker than their counterpart pull-up PFETs 626P(0)(0)(1), 626P(0)(0)(2)-626P(M)(N)(1), 626P(M)(N)(2) to increase natural logic state skew of the challenge memory bit cells 600(1)(0)(0)-600(1)(M)(N). Note that this example can also be applied to the second challenge memory bit cells 600(2)(0)(0)-600(2)(M)(P) in the second PUF challenge memory array 512(2) and/or the response memory bit cells 602(0)(0)-602(Q)(R) in the PUF response memory array 514 in FIG. 6A.

As shown in FIG. 15, using the challenge memory bit cells 600(1)(0)(0)-600(1)(M)(N) in the first PUF challenge memory array 512(1) in FIG. 6A as an example the natural logic state skew of the challenge memory bit cell 600(1)(0)(0) is a logic ‘1’ memory state as stored in its true storage output 624T(0)(0). As discussed above, this can be determined by determining a skew in response to a read operation that includes a read operation to the challenge memory bit cell 600(1)(0)(0). This means that the pull-up PFET 626P(0)(0)(1) is stronger than pull-up PFET 626P(0)(0)(2) in the respective inverters 620(0)(0)(1), 620(0)(0)(2). This is because the pull-up PFET 626P(0)(0)(1) is activated faster to pull the true storage output 624T(0)(0) to the positive supply voltage rail 622P representing a logic state ‘1’, and turn off the pull-down NFET 626N(0)(0)(2) to turn off the pull-up PFET 626P(0)(0)(2) and turn on the pull-down NFET 626N(0)(0)(1) to pull the complement storage output 624C(0)(0) to the supply voltage rail 622N representing a logic state ‘0’. Thus, to further enhance the logic state skew of the challenge memory bit cell 600(1)(0)(0), in this example, a write driver circuit 552(1) can write a reverse memory state of a logic ‘0’ to the true storage output 624T(0)(0) and a logic ‘1’ to the complement storage output 624C(0)(0) as shown in FIG. 15. This is so that the pull-up PFET 626P(0)(0)(1) is turned off and the pull-up PFET 626P(0)(0)(2) to be weakened by stress voltage is turned on. The write driver circuit 552(1) can apply a stress voltage greater than the positive supply voltage V_{DD} to the positive supply voltage rail 622P. The write driver circuit 552(1) can apply a stress voltage greater than the positive supply voltage V_{DD} to the word line WL(0), which also activates the NFET access transistors 628(0)(0)(1), 628(0)(0)(2). The write driver circuit 552(1) can apply a lower voltage (e.g., V_{SS} or 0V) to the complement bit line BLB(0) so that there is a positive voltage drop from the positive supply voltage rail 622P through the pull-up PFET 626P(0)(0)(2) and the NFET access transistor 628(0)(0)(2) to the complement bit line BLB(0) to cause current to flow through the pull-up PFET 626P(0)(0)(2). This places the pull-up PFET 626P(0)(0)(2) in an on state simulating NBTI and/or HCI stress to weaken the pull-up PFET 626P(0)(0)(2) further with respect to the pull-up PFET 626P(0)(0)(1) to enhance the natural logic state skew of the challenge memory bit cell 600(1)(0)(0) to a logic ‘1’ on its true storage output 624T(0)(0).

With continuing reference to FIG. 15, in contrast to the challenge memory bit cell 600(1)(0)(0), the natural logic state skew of the challenge memory bit cell 600(1)(0)(N) was determined to be a logic ‘0’ memory state stored in its true storage output 624T(0)(N). As discussed above, this can be determined in response to a read operation that includes a read operation to the challenge memory bit cell 600(1)(0)(N). This means that the pull-up PFET 626P(0)(N)(2) is stronger than the pull-up PFET 626P(0)(N)(1) in the respective inverters 620(0)(N)(1), 620(0)(N)(2). This is because the pull-up PFET 626P(0)(N)(2) is activated faster to pull the true storage output 624T(0)(N) to the positive supply voltage rail 622P representing a logic state ‘1’, and turn off the pull-down NFET 626N(0)(N)(1) to turn off the pull-up PFET 626P(0)(N)(1) and turn on the pull-down NFET 626N(0)(N)(1) to pull the complement storage output 624C(0)(N) to the supply voltage rail 622N representing a logic state ‘0’. Thus, to further enhance the logic state skew of the challenge memory bit cell 600(1)(0)(N), in this example, the write driver circuit 552(1) can write a reverse memory state of a logic ‘1’ to the true storage output 624T(0)(N) and a logic ‘0’ to the complement storage output 624C(0)(N) as shown in FIG. 15. This is so that the pull-up PFET 626P(0)(N)(2) is turned off and the pull-up PFET 626P(0)(N)(1) to be weakened by stress voltage is turned on. The write driver circuit 552(1) can apply a stress voltage greater than the positive supply voltage V_{DD} to the positive supply voltage rail 622P. The write driver circuit 552(1) can also apply a stress voltage greater than the positive supply voltage V_{DD} to the word line WL(0), which also activates the NFET access transistors 628(0)(N)(1), 628(0)(N)(2). The write driver circuit 552(1) can also apply a lower voltage (e.g., V_{SS} or 0V) to the bit line BL(N) so that there is a positive voltage drop from the positive supply voltage rail 622P through the pull-up PFET 626P(0)(N)(1) and the NFET access transistor 628(0)(N)(1) to the bit line BL(N) to cause current to flow through the pull-up PFET 626P(0)(N)(1). This places the pull-up PFET 626P(0)(N)(1) in an on state simulating NBTI and/or HCI stress to weaken the pull-up PFET 626P(0)(N)(1) further with respect to the pull-up PFET 626P(0)(N)(2) to enhance the natural logic state skew of the challenge memory bit cell 600(1)(0)(0) to a logic ‘0’ on its true storage output 624T(0)(N).

When the pull-up PFET 626P(0)(0)(2) in the inverter 620(0)(0)(2) in memory bit cell 600(1)(0)(0) is weakened by stress voltage as shown in FIG. 15, the pull-down NFET 626N(0)(0)(1) in the other inverter 620(0)(0)(1) can also be stressed and weakened. This is to further enhance the natural logic state skew of the challenge memory bit cell 600(1)(0)(0) to a logic ‘1’ state on its true storage output 624T(0)(0), because weakening the pull-down NFET 626N(0)(0)(1) means that the pull-down NFET 626N(0)(0)(1) is less likely to switch on fast enough to pull the true storage output 624T(0)(0) to the supply voltage rail 622N before the pull-up PFET 626P(0)(0)(1) pulls the true storage output 624T(0)(N) to the positive supply voltage rail 622P, thus flipping the natural logic state skew of the challenge memory bit cell 600(1)(0)(0) to a logic ‘0’ state in an undesired manner.

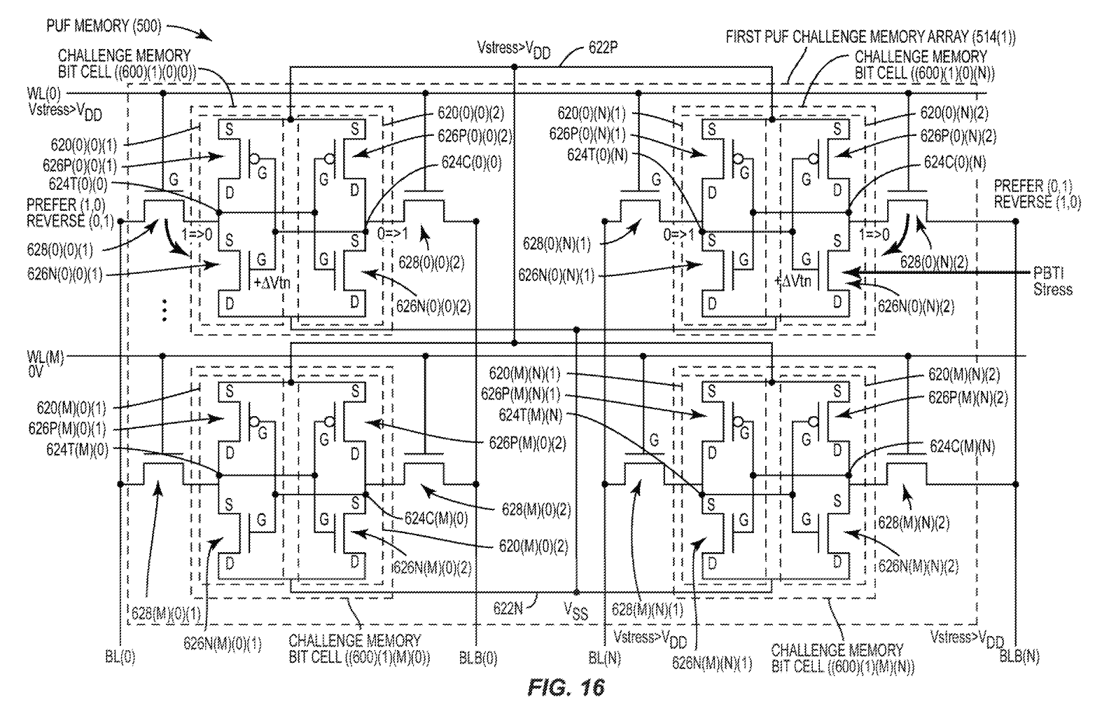

Similarly, such as shown in FIG. 15, when the pull-up PFET 626P(0)(N)(1) in the inverter 620(0)(N)(1) in the challenge memory bit cell 600(1)(0)(N) is weakened by stress voltage, the pull-down NFET 626N(0)(N)(2) in the other inverter 620(0)(N)(2) can also be stressed and weakened. This is to also further enhance the natural logic state skew of the challenge memory bit cell 600(1)(0)(N) to a logic ‘0’ state on its true storage output 624T(0)(N), because weakening the pull-down NFET 626N(0)(N)(2) means that the pull-down NFET 626N(0)(N)(2) is less likely to switch on fast enough to pull the true storage output 624T(0)(N) to the supply voltage rail 622N before the pull-up PFET 626P(0)(N)(2) pulls the true storage output 624T(0)(N) to the positive supply voltage rail 622P, which could flip the natural logic state skew of the challenge memory bit cell 600(1)(0)(N) to a logic ‘0’ state in an undesired manner This is shown in FIG. 16, which is now discussed.

As shown in FIG. 16, as discussed above, the natural logic state skew of the challenge memory bit cell 600(1)(0)(0) is a logic ‘1’ memory state as stored in its true storage output 624T(0)(0). To further enhance the logic state skew of the challenge memory bit cell 600(1)(0)(0) in this example, the write driver circuit 552(1) writes a reverse memory state of a logic ‘0’ to the true storage output 624T(0)(0) and a logic ‘1’ to the complement storage output 624C(0)(0) as previously discussed. This is so that the pull-up PFET 626P(0)(0)(1) is turned off and the pull-up PFET 626P(0)(0)(2) to be weakened by stress voltage is turned on. This also turns on the pull-down NFET 626N(0)(0)(1) to be weakened. Again, the write driver circuit 552(1) can cause the supply voltage rail stress circuit 654 to apply a stress voltage greater than the positive supply voltage V_{DD} to the positive supply voltage rail 622P. The write driver circuit 552(1) can also apply a stress voltage greater than the positive supply voltage V_{DD} to the word line WL(0), which also activates the NFET access transistors 628(0)(0)(1), 628(0)(0)(2). The write driver circuit 552(1) can also apply stress voltage greater than the positive supply voltage V_{DD} to the bit line BL(0). This is so that there is a positive voltage drop from the bit line BL(0) through the NFET access transistor 628(0)(0)(1) and the pull-down NFET 626N(0)(0)(1) to the supply voltage rail 622N to cause current to flow from the bit line BL(0) to the supply voltage rail 622N. This places the pull-down NFET 626N(0)(0)(1) in an on state simulating NBTI and/or HCI stress to weaken the pull-down NFET 626N(0)(0)(1) further to enhance the natural logic state skew of the challenge memory bit cell 600(1)(0)(0) to a logic ‘1’ on its true storage output 624T(0)(0).

With continuing reference to FIG. 16, in contrast to the challenge memory bit cell 600(1)(0)(0), the natural logic state skew of the challenge memory bit cell 600(1)(0)(N) was determined to be a logic ‘0’ memory state stored in its true storage output 624T(0)(N) as previously discussed. Thus, to further enhance the logic state skew of the challenge memory bit cell 600(1)(0)(N), in this example, the write driver circuit 552(1) writes a reverse memory state of a logic ‘1’ to the true storage output 624T(0)(N) and a logic ‘0’ to the complement storage output 624C(0)(N) as previously discussed. The write driver circuit 552(1) can also apply a stress voltage greater than the positive supply voltage V_{DD} to the word line WL(0), which also activates the NFET access transistors 628(0)(N)(1), 628(0)(N)(2). The write driver circuit 552(1) can also apply stress voltage greater than the positive supply voltage V_{DD} to the complement bit line BLB(N). This is so that there is a positive voltage drop from the complement bit line BLB(N) through the NFET access transistor 628(0)(N)(2) and the pull-down NFET 626N(0)(N)(2) to the supply voltage rail 622N to cause current to flow from the complement bit line BLB(N) to the supply voltage rail 622N. This places the pull-down NFET 626N(0)(N)(2) in an on state simulating NBTI and/or HCI stress to weaken the pull-down NFET 626N(0)(N)(2) further to enhance the natural logic state skew of the challenge memory bit cell 600(1)(0)(N) to a logic ‘1’ on its true storage output 624T(0)(N).

A defined number of PUF read operations can be performed on the challenge memory bit cells 600(1)(0)(0)-600(1)(M)(N), 600(2)(0)(0)-600(2)(Q)(R) and/or the response memory bit cells 602(0)(0)-602(Q)(R) to determine their natural logic state skews. The first and second intermediate PUF challenge outputs 522(1)(0)-522(1)(M), 522(2)(0)-522(2)(P) and/or the PUF response output data word 524(0)-524(R) for accessed challenge memory bit cells 600(1)(0)(0)-600(1)(M)(N), 600(2)(0)(0)-600(2)(Q)(R) and/or the response memory bit cells 602(0)(0)-602(Q)(R) for a PUF read operation can be recorded and analyzed to determine the natural logic state skews of the challenge memory bit cells 600(1)(0)(0)-600(1)(M)(N), 600(2)(0)(0)-600(2)(Q)(R) and/or the response memory bit cells 602(0)(0)-602(Q)(R). This may take more time and/or involve additional circuits for recording and analyzing natural logic state skews of the challenge memory bit cells 600(1)(0)(0)-600(1)(M)(N), 600(2)(0)(0)-600(2)(Q)(R) and/or the response memory bit cells 602(0)(0)-602(Q)(R), thereby increasing complexity and power consumption in an undesired manner As another example, the logic state skew of the challenge memory bit cells 600(1)(0)(0)-600(1)(M)(N), 600(2)(0)(0)-600(2)(Q)(R) and/or the response memory bit cells 602(0)(0)-602(Q)(R) could be determined by employing a Bayesian probability analysis as discussed below.

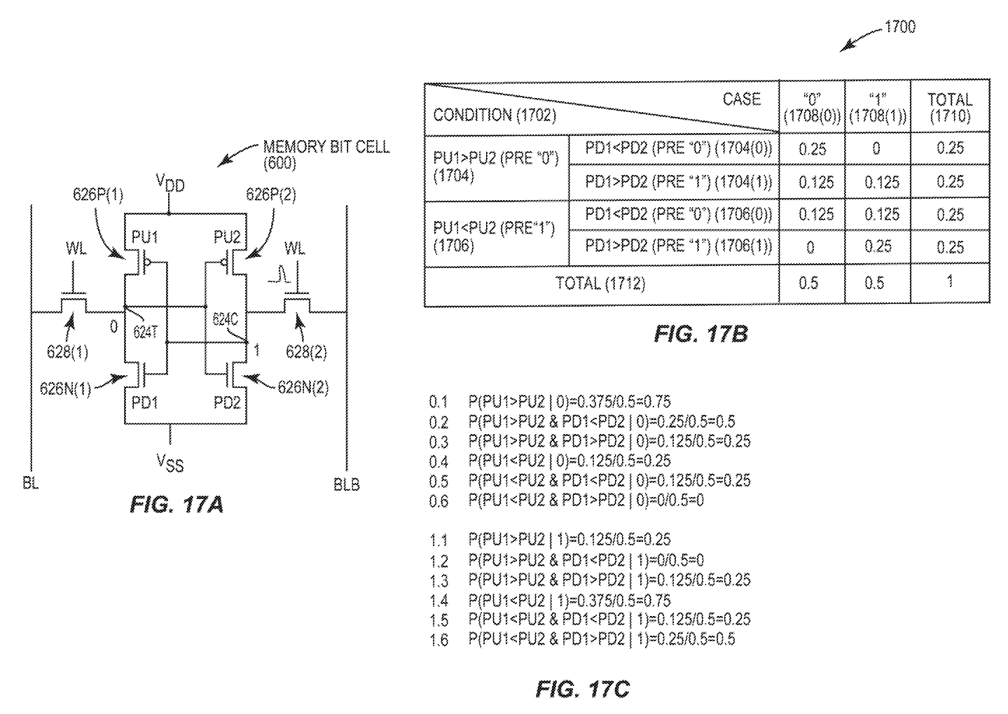

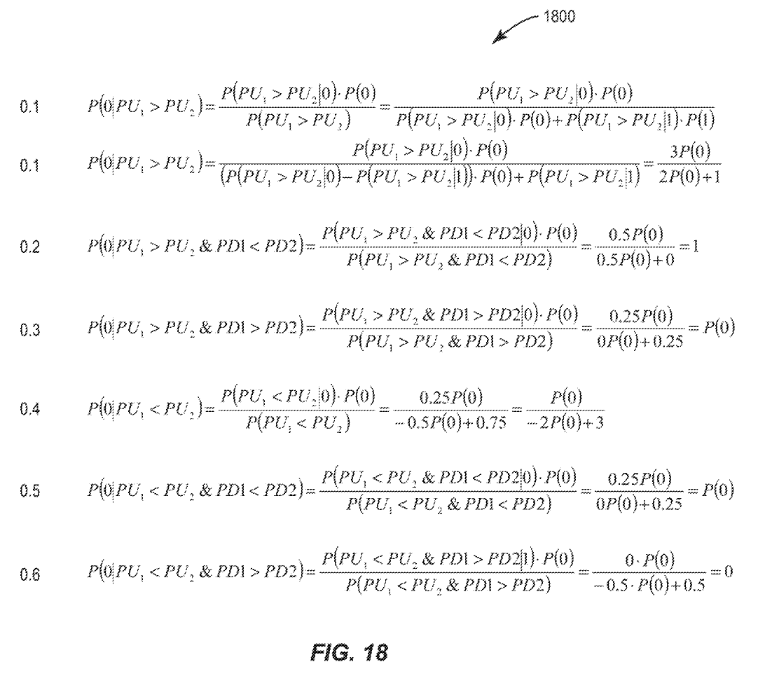

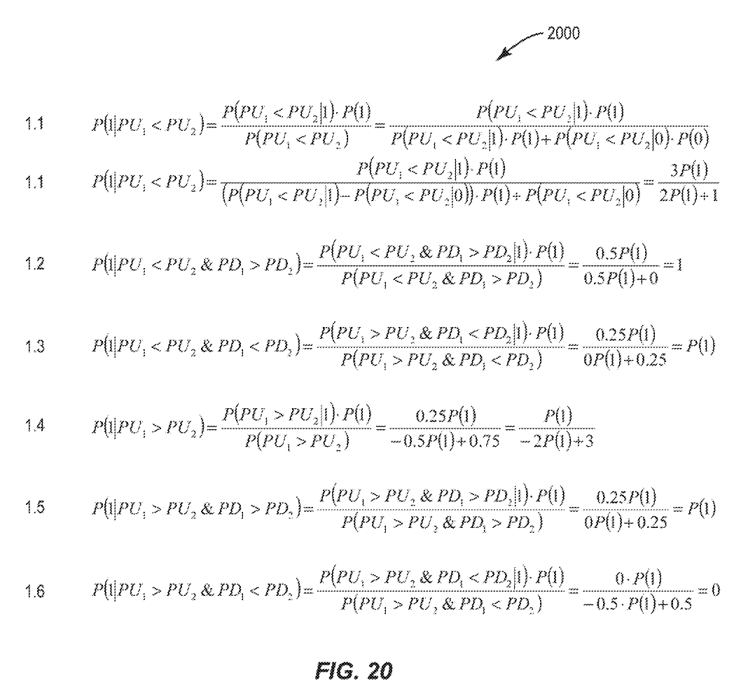

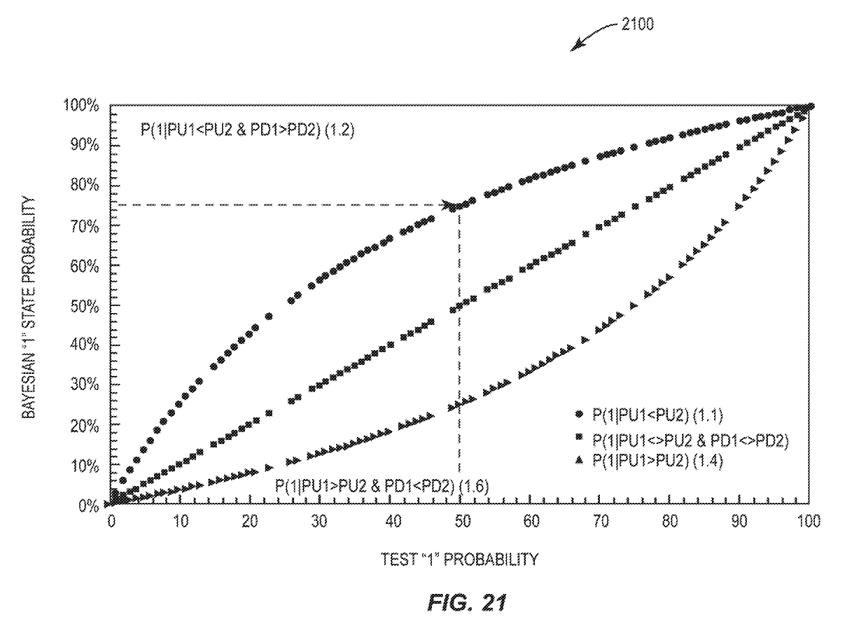

In this regard, FIG. 17A, using the challenge memory bit cells 600(1)(0)(0)-600(1)(M)(N) in the first PUF challenge memory array 512(1) in FIG. 6A as an example, illustrates the challenge memory bit cells 600(1)(0)(0)-600(1)(M)(N) in the first PUF challenge memory array 512(1) in the PUF challenge memory 504 in FIG. 6A with a logic ‘0’ stored on its true storage output 624T as its natural logic state skew. FIG. 17B is a table 1700 illustrating an exemplary likelihood probability analysis of the logic state skew stored in the challenge memory bit cell 600 in FIG. 17A based on different strength comparisons between pull-up PFETs 626P(1), 626P(2) and pull-down NFETs 626N(1), 626N(2) in the challenge memory bit cell 600. As shown in the table 1700, a list of possible conditions 1702 of the challenge memory bit cell 600 is shown in terms of whether pull-up PFET 626P(1) (PU1) is stronger than pull-up PFET 626P(2) (PU2) 1704, or vice versa 1706. For each of these cases, the list of possible conditions 1702 of the challenge memory bit cell 600 of whether pull-down NFET 626N(1) (PD1) is weaker than pull-down NFET 626N(2) (PD2) 1704(0), 1706(0), or vice versa 1704(1), 1706(1). For each case, the table 1700 includes a probability percentage for a logic state skew of ‘0’ 1708(0) or ‘1’ 1708(1), and a total probability 1710. The total probabilities 1710 added up for each logic state skew of ‘0’ 1708(0) or ‘1’ 1708(1), are shown in a total 1712 row. FIG. 17C illustrates exemplary Bayesian probability calculations of the natural logic state skew of the challenge memory bit cell 600 in FIG. 17A being a logic state ‘0’ based on the likelihood probability analysis in FIG. 17B and a read logic state stored in the true storage output 624T in the challenge memory bit cell 600 in equations 0.1-0.6. FIG. 17C also illustrates exemplary Bayesian probability calculations of the natural logic state skew of the challenge memory bit cell 600 in FIG. 17A being a logic state ‘1’ based on the likelihood probability analysis in FIG. 17B and a read logic state stored in the true storage output 624T in the challenge memory bit cell 600 in equations 1.1-1.6. FIG. 18 illustrates a derivation of formulas 1800 for the Bayesian probability calculations shown in FIG. 17C for a natural logic state skew of ‘0’ in the challenge memory bit cell 600 in FIG. 17A. FIG. 20 illustrates a derivation of formulas 2000 for the Bayesian probability calculations shown in FIG. 17C for a natural logic state skew of ‘1’ in the challenge memory bit cell 600 in FIG. 17A.

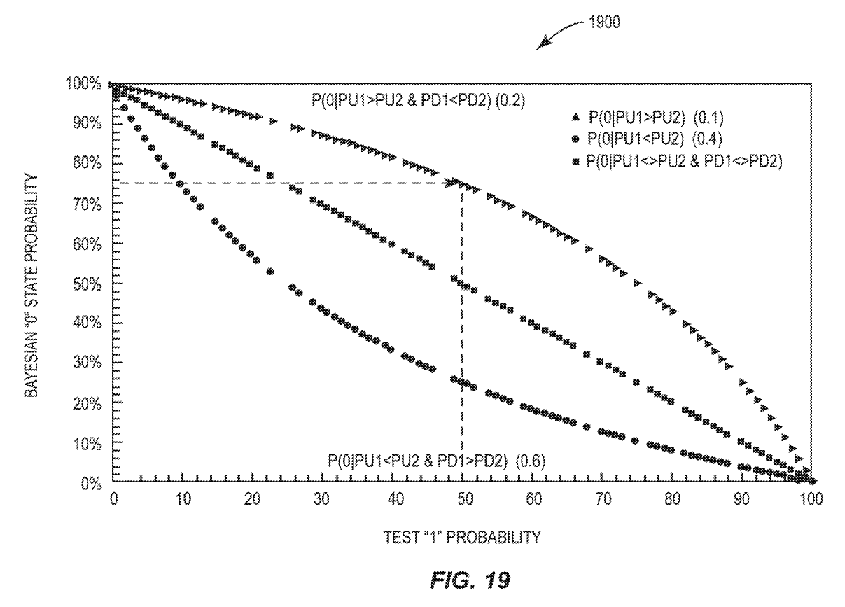

FIG. 19 is a graph 1900 illustrating a Bayesian inference probability curve for a natural logic state skew of ‘0’ based on the Bayesian probability calculations in FIGS. 17B and 18. As shown therein, for a test probability of logic state ‘1’ below 50% for a memory bit cell 600, as shown in an X-axis of the graph 1900, the Bayesian probability of the logic state of the challenge memory bit cell 600 has a logic state skew of ‘0’ is 75%. FIG. 21 is a graph 2100 illustrating a Bayesian inference probability curve for a natural logic state skew of ‘1’ based on the Bayesian probability calculations in FIGS. 17B and 20. As shown therein, for a test probability of logic state ‘1’ above 50% for a memory bit cell 600, as shown in an X-axis of the graph 2100, the Bayesian probability of the logic state of the challenge memory bit cell 600 has a logic state skew of ‘1’ is 75%.

In another exemplary aspect, a PUF circuit is provided. The PUF circuit comprises a means for receiving a PUF challenge input data word indicating a challenge memory address into a PUF circuit. This means may be the PUF challenge input 518 in the PUF circuit 500 in FIGS. 5, 6A, 9, 11, and 13 as non-limiting examples. The PUF circuit also comprises a means for selecting at least one first challenge memory bit cell among a plurality of first challenge memory bit cells in a first PUF challenge memory array in a PUF challenge memory in the PUF circuit based on the means for receiving the PUF challenge input data word. This means may be the challenge decoder circuit 528 and/or the first PUF challenge memory array 512(1) in FIGS. 5, 6A, 9, 11, and 13 as non-limiting examples. The PUF circuit also comprises a means for selecting at least one second challenge memory bit cell among a plurality of second challenge memory bit cells in a second PUF challenge memory array in the PUF challenge memory in the PUF circuit based on the means for receiving the PUF challenge input data word. This means may be the challenge decoder circuit 528 and/or the second PUF challenge memory array 512(2) in FIGS. 5, 6A, 9, 11, and 13 as non-limiting examples. The PUF circuit also comprises a means for generating a first intermediate challenge output data word from the first PUF challenge memory array representing a logic state in response to the means for selecting the at least one first challenge memory bit cell. This means may be the first PUF challenge memory array 512(1) in FIGS. 5, 6A, 9, 11, and 13 as non-limiting examples. The PUF circuit also comprises a means for generating a second intermediate challenge output data word from the second PUF challenge memory array representing a logic state in response to the means for selecting the at least one second challenge memory bit cell. This means may be the second PUF challenge memory array 512(2) in FIGS. 5, 6A, 9, 11, and 13 as non-limiting examples. The PUF circuit also comprises a means for selecting at least one response memory bit cell among a plurality of response memory bit cells in a PUF response memory array in a PUF response memory in the PUF circuit based on the means for generating the first intermediate challenge output data word and the means for generating the second intermediate challenge output data word. This means may be the response decoder circuit 540 and/or the PUF response memory array 514 in FIGS. 5, 6A, 9, 11, and 13 as non-limiting examples. The PUF circuit also comprises a means for generating a PUF response output data word from the PUF response memory array representing a logic state of the selected at least one response memory bit cell in response to the means for selecting the at least one response memory bit cell. This means may be the PUF response memory array 514 in FIGS. 5, 6A, 9, 11, and 13 as non-limiting examples.

A PUF circuit that includes a PUF memory, including but not limited to the PUF memories 502, 902, 1102, and 1302 in FIGS. 5, 6A, 9, 11, and 13, that includes a first PUF challenge memory comprising two (2) PUF challenge memory arrays in a first logical PUF layer configured to generate intermediate response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the input challenge input for enhanced security may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

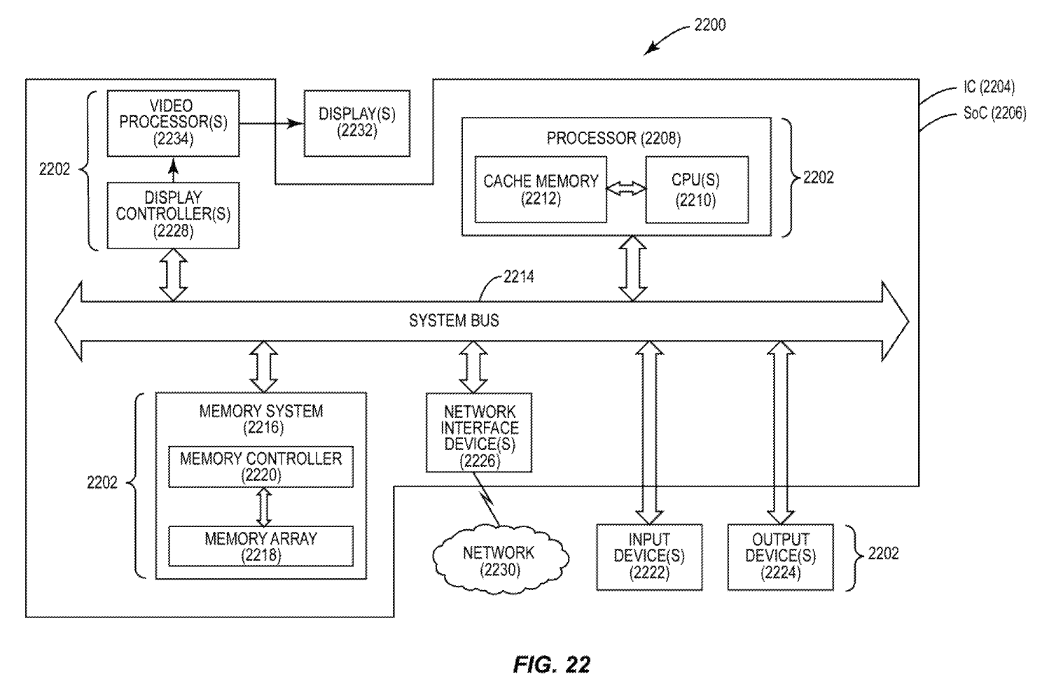

In this regard, FIG. 22 illustrates an example of a processor-based system 2200 that can include one or more PUF circuits 2202 that include a PUF memory, including but not limited to the PUF memories in FIGS. 5, 6A, 9, 11, and 13, that includes a first PUF challenge memory comprises two PUF challenge memory arrays in a first logical PUF layer configured to generate intermediate response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the input challenge input for enhanced security. In this example, the processor-based system 2200 is provided in an IC 2204. The IC 2204 may be included in or provided to as a system-on-a-chip (SoC) 2206. The processor-based system 2200 includes a processor 2208 that includes one or more CPUs 2210. The processor 2208 may include a cache memory 2212 coupled to the CPU(s) 2210 for rapid access to temporarily stored data. The cache memory 2212 may include a PUF circuit 2202 that includes a PUF memory, including but not limited to the PUF memories in FIGS. 5, 6A, 9, 11, and 13, that includes a first PUF challenge memory comprises two PUF challenge memory arrays in a first logical PUF layer configured to generate intermediate response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the input challenge input for enhanced security. The processor 2208 is coupled to a system bus 2214 and can intercouple master and slave devices included in the processor-based system 2200. As is well known, the processor 2208 communicates with these other devices by exchanging address, control, and data information over the system bus 2214. Although not illustrated in FIG. 22, multiple system buses 2214 could be provided, wherein each system bus 2214 constitutes a different fabric. For example, the processor 2208 can communicate bus transaction requests to a memory system 2216 as an example of a slave device. The memory system 2216 may include a memory array 2218 whose access is controlled by a memory controller 2220. The memory system 2216 may be or include a PUF circuit 2202 that includes a PUF memory, including but not limited to the PUF memories in FIGS. 5, 6A, 9, 11, and 13, that includes a first PUF challenge memory comprises two PUF challenge memory arrays in a first logical PUF layer configured to generate intermediate response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the input challenge input for enhanced security.

Other master and slave devices can be connected to the system bus 2214. As illustrated in FIG. 22, these devices can include the memory system 2216, and one or more input devices 2222, which can include a PUF circuit 2202 that includes a PUF memory, including but not limited to the PUF memories in FIGS. 5, 6A, 9, 11, and 13, that includes a first PUF challenge memory comprises two PUF challenge memory arrays in a first logical PUF layer configured to generate intermediate response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the input challenge input for enhanced security. The input device(s) 2222 can include any type of input device, including but not limited to input keys, switches, voice processors, etc. The other devices can also include one or more output devices 2224, and one or more network interface devices 2226, both of which can include a PUF circuit 2202 that includes a PUF memory, including but not limited to the PUF memories in FIGS. 5, 6A, 9, 11, and 13, that includes a first PUF challenge memory comprises two PUF challenge memory arrays in a first logical PUF layer configured to generate intermediate response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the input challenge input for enhanced security. The output device(s) 2224 can include any type of output device, including but not limited to audio, video, other visual indicators, etc. The other devices can also include one or more display controllers 2228 as examples. The network interface device(s) 2226 can be any devices configured to allow exchange of data to and from a network 2230. The network 2230 can be any type of network, including but not limited to a wired or wireless network, a private or public network, a local area network (LAN), a wireless local area network (WLAN), a wide area network (WAN), a BLUETOOTH™ network, and the Internet. The network interface device(s) 2226 can be configured to support any type of communications protocol desired.

The processor 2208 may also be configured to access the display controller(s) 2228 over the system bus 2214 to control information sent to one or more displays 2232. The display controller(s) 2228 sends information to the display(s) 2232 to be displayed via one or more video processors 2234, which process the information to be displayed into a format suitable for the display(s) 2232. The display controller(s) 2228 and the video processor(s) 2234 can include a PUF circuit 2202 that includes a PUF memory, including but not limited to the PUF memories 502, 902, 1102, 1302 in FIGS. 5, 6A, 9, 11, and 13, that includes a first PUF challenge memory comprises two PUF challenge memory arrays in a first logical PUF layer configured to generate intermediate response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the input challenge input for enhanced security. The display(s) 1432 can include any type of display, including but not limited to a cathode ray tube (CRT), a liquid crystal display (LCD), a plasma display, etc.

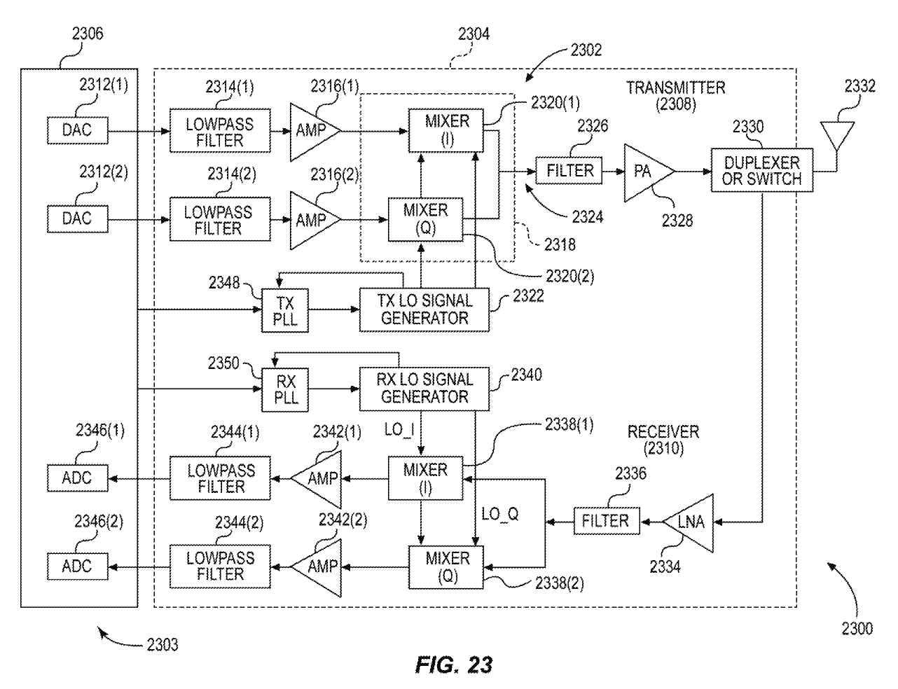

FIG. 23 illustrates an exemplary wireless communications device 2300 that includes radio frequency (RF) components formed in an IC 2302, wherein any of the components therein can include a PUF circuit 2303 that includes a PUF memory, including but not limited to the PUF memories 502, 902, 1102, 1302 in FIGS. 5, 6A, 9, 11, and 13, that includes a first PUF challenge memory comprises two PUF challenge memory arrays in a first logical PUF layer configured to generate intermediate response outputs in response to a challenge input into the PUF circuit, and a PUF response memory comprising a PUF response memory array in a second logical PUF layer configured to be addressed by the intermediate PUF response outputs as intermediate challenge inputs to generate a PUF response output for the PUF circuit, to decouple the PUF response output from the input challenge input for enhanced security.

In this regard, the wireless communications device 2300 may be provided in the IC 2302. The wireless communications device 2300 may include or be provided in any of the above referenced devices, as examples. As shown in FIG. 23, the wireless communications device 2300 includes a transceiver 2304 and a data processor 2306. The data processor 2306 may include a memory to store data and program codes. The transceiver 2304 includes a transmitter 2308 and a receiver 2310 that support bi-directional communications. In general, the wireless communications device 2300 may include any number of transmitters 2308 and/or receivers 2310 for any number of communication systems and frequency bands. All or a portion of the transceiver 2304 may be implemented on one or more analog ICs, RF ICs (RFICs), mixed-signal ICs, etc.

The transmitter 2308 or the receiver 2310 may be implemented with a super-heterodyne architecture or a direct-conversion architecture. In the super-heterodyne architecture, a signal is frequency-converted between RF and baseband in multiple stages, e.g., from RF to an intermediate frequency (IF) in one stage, and then from IF to baseband in another stage for the receiver 2310. In the direct-conversion architecture, a signal is frequency-converted between RF and baseband in one stage. The super-heterodyne and direct-conversion architectures may use different circuit blocks and/or have different requirements. In the wireless communications device 2300 in FIG. 23, the transmitter 2308 and the receiver 2310 are implemented with the direct-conversion architecture.

In the transmit path, the data processor 2306 processes data to be transmitted and provides I and Q analog output signals to the transmitter 2308. In the exemplary wireless communications device 2300, the data processor 2306 includes digital-to-analog converters (DACs) 2312(1), 2312(2) for converting digital signals generated by the data processor 2306 into the I and Q analog output signals, e.g., I and Q output currents, for further processing.

Within the transmitter 2308, lowpass filters 2314(1), 2314(2) filter the I and Q analog output signals, respectively, to remove undesired signals caused by the prior digital-to-analog conversion. Amplifiers (AMP) 2316(1), 2316(2) amplify the signals from the lowpass filters 2314(1), 2314(2), respectively, and provide I and Q baseband signals. An upconverter 2318 upconverts the I and Q baseband signals with I and Q transmit (TX) local oscillator (LO) signals through mixers 2320(1), 2320(2) from a TX LO signal generator 2322 to provide an upconverted signal 2324. A filter 2326 filters the upconverted signal 2324 to remove undesired signals caused by the frequency upconversion as well as noise in a receive frequency band. A power amplifier (PA) 2328 amplifies the upconverted signal 2324 from the filter 2326 to obtain the desired output power level and provides a transmit RF signal. The transmit RF signal is routed through a duplexer or switch 2330 and transmitted via an antenna 2332.

In the receive path, the antenna 2332 receives signals transmitted by base stations and provides a received RF signal, which is routed through the duplexer or switch 2330 and provided to a low noise amplifier (LNA) 2334. The duplexer or switch 2330 is designed to operate with a specific receive (RX)-to-TX duplexer frequency separation, such that RX signals are isolated from TX signals. The received RF signal is amplified by the LNA 2334 and filtered by a filter 2336 to obtain a desired RF input signal. Downconversion mixers 2338(1), 2338(2) mix the output of the filter 2336 with I and Q RX LO signals (i.e., LO_I and LO_Q) from an RX LO signal generator 2340 to generate I and Q baseband signals. The I and Q baseband signals are amplified by amplifiers (AMP) 2342(1), 2342(2) and further filtered by lowpass filters 2344(1), 2344(2) to obtain I and Q analog input signals, which are provided to the data processor 2306. In this example, the data processor 2306 includes ADCs 2346(1), 2346(2) for converting the analog input signals into digital signals to be further processed by the data processor 2306.

In the wireless communications device 2300 of FIG. 23, the TX LO signal generator 2322 generates the I and Q TX LO signals used for frequency upconversion, while the RX LO signal generator 2340 generates the I and Q RX LO signals used for frequency downconversion. Each LO signal is a periodic signal with a particular fundamental frequency. A TX phase-locked loop (PLL) circuit 2348 receives timing information from the data processor 2306 and generates a control signal used to adjust the frequency and/or phase of the TX LO signals from the TX LO signal generator 2322. Similarly, an RX PLL circuit 2350 receives timing information from the data processor 2306 and generates a control signal used to adjust the frequency and/or phase of the RX LO signals from the RX LO signal generator 2340.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A physically unclonable function (PUF) circuit, comprising:
a PUF challenge input configured to receive a PUF challenge input data word comprising a challenge memory address;
a PUF challenge memory, comprising:
a first PUF challenge memory array, comprising:
a plurality of first challenge memory bit cells each configured to store a logic state; and
a first intermediate PUF challenge output coupled to the plurality of first challenge memory bit cells; and
a second PUF challenge memory array, comprising:
a plurality of second challenge memory bit cells each configured to store a logic state; and
a second intermediate PUF challenge output coupled to the plurality of second challenge memory bit cells; and
a challenge memory bit cell selection input coupled to the first PUF challenge memory array and the second PUF challenge memory array, the challenge memory bit cell selection input configured to receive a challenge memory selection signal based on the challenge memory address in the PUF challenge input data word on the PUF challenge input; and
a PUF response memory, comprising:
a PUF response memory array, comprising:
a plurality of response memory bit cells each configured to store a logic state; and
a PUF response output coupled to the plurality of response memory bit cells;
a first response memory bit cell selection input coupled to the first intermediate PUF challenge output and the plurality of response memory bit cells; and
a second response memory bit cell selection input coupled to the second intermediate PUF challenge output and the plurality of response memory bit cells.

2. The PUF circuit of claim 1, wherein:
the first PUF challenge memory array is configured to generate a first intermediate PUF challenge output data word on the first intermediate PUF challenge output representing a logic state stored in at least one challenge memory bit cell in the plurality of first challenge memory bit cells, based on the challenge memory selection signal on the challenge memory bit cell selection input;
the second PUF challenge memory array is configured to generate a second intermediate PUF challenge output data word on the second intermediate PUF challenge output representing a logic state stored in at least one challenge memory bit cell in the plurality of second challenge memory bit cells, based on the challenge memory selection signal on the challenge memory bit cell selection input; and
the PUF response memory array is configured to output a PUF response output data word on the PUF response output representing a logic state stored in at least one response memory bit cell among the plurality of response memory bit cells, based on a response memory selection signal on the first response memory bit cell selection input based on the first intermediate PUF challenge output data word on the first response memory bit cell selection input, and the second intermediate PUF challenge output data word on the second response memory bit cell selection input.

3. The PUF circuit of claim 1, wherein:
the first PUF challenge memory array further comprises:
a plurality of first challenge memory bit cell row circuits each comprising a plurality of memory bit cells among the plurality of first challenge memory bit cells; and
a plurality of first challenge PUF bit cell column circuits each comprising a memory bit cell among the plurality of first challenge memory bit cells from a challenge memory bit cell row circuit among the plurality of first challenge memory bit cell row circuits; and
the second PUF challenge memory array further comprises:
a plurality of second challenge memory bit cell row circuits each comprising a plurality of memory bit cells among the plurality of second challenge memory bit cells; and
a plurality of second challenge memory bit cell column circuits each comprising a memory bit cell among the plurality of second challenge memory bit cells from a challenge memory bit cell row circuit among the plurality of second challenge memory bit cell row circuits.

4. The PUF circuit of claim 3, wherein:
the challenge memory bit cell selection input comprises a first word line coupled to the plurality of first challenge memory bit cell row circuits and the plurality of second challenge memory bit cell row circuits; and
the PUF challenge memory further comprises:
a first challenge memory bit cell column input coupled to the plurality of first challenge memory bit cell column circuits; and
a second challenge memory bit cell column input coupled to the plurality of second challenge memory bit cell column circuits.

5. The PUF circuit of claim 4, wherein:
the first PUF challenge memory array is configured to generate a first intermediate PUF challenge output data word on the first intermediate PUF challenge output representing the logic state stored in at least one challenge memory bit cell in the plurality of first challenge memory bit cells, based on the challenge memory selection signal on the challenge memory bit cell selection input and a first challenge column input signal on the first challenge memory bit cell column input; and
the second PUF challenge memory array is configured to generate a second intermediate PUF challenge output data word on the second intermediate PUF challenge output representing the logic state stored in at least one challenge memory bit cell in the plurality of second challenge memory bit cells, based on the challenge memory selection signal on the challenge memory bit cell selection input and a second challenge column input signal on the second challenge memory bit cell column input.

6. The PUF circuit of claim 4, wherein:
the first challenge memory bit cell column input comprises a plurality of first bit lines and a corresponding plurality of first complementary bit lines;
a first bit line among the plurality of first bit lines and a first complementary bit line among the plurality of first bit lines, are coupled to each first challenge memory bit cell column circuit among the plurality of first challenge memory bit cell column circuits; and
the second challenge memory bit cell column input comprises a plurality of second bit lines and a corresponding plurality of second complementary bit lines;
a second bit line among the plurality of second bit lines and a second complementary bit line among the plurality of second bit lines, are coupled to each second challenge memory bit cell column circuit among the plurality of second challenge memory bit cell column circuits.

7. The PUF circuit of claim 1, wherein:
the PUF response memory array further comprises:
a plurality of response memory bit cell row circuits each comprising a plurality of memory bit cells among the plurality of response memory bit cells; and
a plurality of response memory bit cell column circuits each comprising a memory bit cell among the plurality of response memory bit cells from a response memory bit cell row circuit among the plurality of response memory bit cell row circuits.

8. The PUF circuit of claim 7, wherein:
the first response memory bit cell selection input comprises a second word line coupled to the plurality of response memory bit cell row circuits; and
the second response memory bit cell selection input comprises a response memory bit cell column input coupled to the plurality of response memory bit cell column circuits.

9. The PUF circuit of claim 8, wherein:
the response memory bit cell column input comprises a plurality of third bit lines and a corresponding plurality of third complementary bit lines,
a third bit line among the plurality of third bit lines and a third complementary bit line among the plurality of third bit lines, are coupled to each third PUF bit cell column circuit among the plurality of response memory bit cell column circuits.

10. The PUF circuit of claim 1, wherein:
the first PUF challenge memory array further comprises a first challenge read enable input coupled to the plurality of first challenge memory bit cells;
the second PUF challenge memory array further comprises a second challenge read enable input coupled to the plurality of second challenge memory bit cells; and
the PUF response memory array further comprises a response read enable input coupled to the plurality of response memory bit cells.

11. The PUF circuit of claim 10, wherein:
the first PUF challenge memory array is configured to generate a first intermediate PUF challenge output data word on the first intermediate PUF challenge output representing a logic state stored in at least one challenge memory bit cell in the plurality of first challenge memory bit cells, based on the challenge memory selection signal on the challenge memory bit cell selection input, in response to a read enable signal on the first challenge read enable input;
the second PUF challenge memory array is configured to generate a second intermediate PUF challenge output data word on the second intermediate PUF challenge output representing a logic state stored in at least one challenge memory bit cell in the plurality of second challenge memory bit cells, based on the challenge memory selection signal on the challenge memory bit cell selection input, in response to a read enable signal on the second challenge read enable input; and
the PUF response memory array is configured to output a PUF response output data word on the PUF response output representing a logic state stored in at least one response memory bit cell among the plurality of response memory bit cells, based on the first intermediate PUF challenge output data word on the first response memory bit cell selection input and the second intermediate PUF challenge output data word on the second response memory bit cell selection input, in response to a read enable signal on the response read enable input.

12. The PUF circuit of claim 1, wherein:
the first PUF challenge memory array further comprises a first challenge equalization enable input coupled to the plurality of first challenge memory bit cells;
the second PUF challenge memory array further comprises a second challenge equalization enable input coupled to the plurality of second challenge memory bit cells; and
the PUF response memory array further comprises a response equalization enable input coupled to the plurality of response memory bit cells.

13. The PUF circuit of claim 12, wherein:
the first PUF challenge memory array is configured to equalize the first intermediate PUF challenge output in response to a challenge equalization enable signal on the first challenge equalization enable input;
the second PUF challenge memory array is configured to equalize the second intermediate PUF challenge output in response to a challenge equalization enable signal on the second challenge equalization enable input; and
the PUF response memory array is configured to equalize the PUF response output in response to a response equalization enable signal on the response equalization enable input.

14. The PUF circuit of claim 2, wherein:
the PUF challenge memory further comprises:
a challenge decoder circuit coupled to the PUF challenge input and the challenge memory bit cell selection input, the challenge decoder circuit configured to decode the challenge memory address on the PUF challenge input to the challenge memory selection signal on the challenge memory bit cell selection input; and
the PUF response memory further comprises:
a response decoder circuit coupled to the first intermediate PUF challenge output and the first response memory bit cell selection input, the response decoder circuit configured to decode the first intermediate PUF challenge output data word on the first intermediate PUF challenge output to generate a response memory selection signal on the first response memory bit cell selection input.

15. The PUF circuit of claim 4, wherein:
the PUF challenge memory further comprises:
a first challenge read driver circuit coupled to the first challenge memory bit cell column input, the first challenge read driver circuit configured to assert a first challenge read signal on the first challenge memory bit cell column input; and
a second challenge read driver circuit coupled to the second challenge memory bit cell column input, the second challenge read driver circuit configured to assert a second challenge read signal on the second challenge memory bit cell column input.

16. The PUF circuit of claim 8, wherein:
the PUF response memory further comprises:
a response read driver circuit coupled to the response memory bit cell column input, the response read driver circuit configured to assert a second intermediate PUF challenge output data word on the response memory bit cell column input.

17. The PUF circuit of claim 4, wherein:
the PUF challenge memory further comprises:
a first challenge write driver circuit coupled to the first challenge memory bit cell column input, the first challenge write driver circuit configured to assert a first challenge write signal on the first challenge memory bit cell column input to be written to the first PUF challenge memory array; and
a second challenge write driver circuit coupled to the second challenge memory bit cell column input, the second challenge write driver circuit configured to assert a second challenge write signal on the second challenge memory bit cell column input to be written to the second PUF challenge memory array.

18. The PUF circuit of claim 8, wherein:
the PUF response memory further comprises:
a response write driver circuit coupled to the response memory bit cell column input, the response write driver circuit configured to assert a response write data signal on the response memory bit cell column input to be written to the PUF response memory array.

19. The PUF circuit of claim 1, further configured to:
receive the first intermediate PUF challenge output from the first PUF challenge memory array based on a logic state stored in at least one challenge memory bit cell among the plurality of first challenge memory bit cells in the first PUF challenge memory array;
receive the second intermediate PUF challenge output from the second PUF challenge memory array based on a logic state stored in at least one challenge memory bit cell among the plurality of second challenge memory bit cells in the second PUF challenge memory array;
receive the PUF response output from the PUF response memory array based on a logic state stored in at least one response memory bit cell among the plurality of response memory bit cells in the PUF response memory array;
determine a first challenge logic state skew of the accessed at least one challenge memory bit cell among the plurality of first challenge memory bit cells based on the first intermediate PUF challenge output;
determine a second challenge logic state skew of the at least one challenge memory bit cell among the plurality of second challenge memory bit cells based on the second intermediate PUF challenge output;
determine a response logic state skew of the at least one response memory bit cell among the plurality of response memory bit cells based on the PUF response output;
cause a stress voltage to be applied to the at least one challenge memory bit cell among the plurality of first challenge memory bit cells in the first PUF challenge memory array based on the determined first challenge logic state skew;
cause a stress voltage to be applied to the at least one challenge memory bit cell among the plurality of second challenge memory bit cells in the second PUF challenge memory array based on the determined second challenge logic state skew; and
cause a stress voltage to be applied to the at least one response memory bit cell among the plurality of response memory bit cells in the PUF response memory array based on the determined response challenge logic state skew.

20. The PUF circuit of claim 1 integrated into an integrated circuit (IC).

21. The PUF circuit of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

22. A physically unclonable function (PUF) circuit, comprising:
a means for receiving a PUF challenge input data word indicating a challenge memory address to access in a PUF circuit;
a means for selecting at least one first challenge memory bit cell among a plurality of first challenge memory bit cells in a first PUF challenge memory array in a PUF challenge memory in the PUF circuit based on the means for receiving the PUF challenge input data word;
a means for selecting at least one second challenge memory bit cell among a plurality of second challenge memory bit cells in a second PUF challenge memory array in the PUF challenge memory in the PUF circuit based on the means for receiving the PUF challenge input data word;
a means for generating a first intermediate PUF challenge output data word from the first PUF challenge memory array representing a logic state in response to the means for selecting the at least one first challenge memory bit cell;
a means for generating a second intermediate PUF challenge output data word from the second PUF challenge memory array representing a logic state in response to the means for selecting the at least one second challenge memory bit cell;
a means for selecting at least one response memory bit cell among a plurality of response memory bit cells in a PUF response memory array in a PUF response memory in the PUF circuit based on the means for generating the first intermediate PUF challenge output data word and the means for generating the second intermediate PUF challenge output data word; and
a means for generating a PUF response output data word from the PUF response memory array representing a logic state of the selected at least one response memory bit cell in response to the means for selecting the at least one response memory bit cell.

23. A method of generating a physically unclonable function (PUF) response output in a PUF circuit, comprising:
receiving a PUF challenge input data word indicating a challenge memory address into a PUF circuit;
selecting at least one first challenge memory bit cell among a plurality of first challenge memory bit cells in a first PUF challenge memory array in a PUF challenge memory in the PUF circuit based on the challenge memory address;
selecting at least one second challenge memory bit cell among a plurality of second challenge memory bit cells in a second PUF challenge memory array in the PUF challenge memory in the PUF circuit based on the challenge memory address;
generating a first intermediate PUF challenge output data word from the first PUF challenge memory array representing a logic state of the selected at least one first challenge memory bit cell;
generating a second intermediate PUF challenge output data word from the second PUF challenge memory array representing a logic state of the selected at least one second challenge memory bit cell;
selecting at least one response memory bit cell among a plurality of response memory bit cells in a PUF response memory array in a PUF response memory in the PUF circuit based on the first intermediate PUF challenge output data word and the second intermediate PUF challenge output data word; and
generating a PUF response output data word from the PUF response memory array representing a logic state of the selected at least one response memory bit cell.

24. The method of claim 23, further comprising:
decoding the challenge memory address into a challenge memory bit cell selection signal; and
wherein:
selecting the at least one first challenge memory bit cell comprises selecting a challenge memory bit cell row circuit among a plurality of first challenge memory bit cell row circuits in the first PUF challenge memory array, each challenge memory bit cell row circuit among the plurality of first challenge memory bit cell row circuits comprising at least one challenge memory bit cell among the plurality of first challenge memory bit cells, based on the challenge memory bit cell selection signal;
selecting the at least one second challenge memory bit cell comprises selecting a challenge memory bit cell row circuit among a plurality of second challenge memory bit cell row circuits in the second PUF challenge memory array, each challenge memory bit cell row circuit among the plurality of second challenge memory bit cell row circuits comprising at least one challenge memory bit cell among the plurality of second challenge memory bit cells, based on the challenge memory bit cell selection signal;
generating the first intermediate PUF challenge output data word comprises generating the first intermediate challenge output data word from the first PUF challenge memory array representing a logic state of the selected challenge memory bit cell row circuit;
generating the second intermediate PUF challenge output data word comprises generating the second intermediate challenge output data word from the second PUF challenge memory array representing a logic state of the selected challenge memory bit cell row circuit;
selecting the at least one response memory bit cell comprises selecting a response memory bit cell row circuit among a plurality of response memory bit cell row circuits in the second PUF challenge memory array, each response memory bit cell row circuit among the plurality of response memory bit cell row circuits comprising at least one response memory bit cell among the plurality of response memory bit cells, based on the first intermediate PUF challenge output data word and the second intermediate PUF challenge output data word; and
generating the PUF response output data word comprises generating the PUF response output data word representing a logic state of the selected response memory bit cell row circuit from the PUF response memory array representing the logic state of the selected response memory bit cell row circuit.

25. The method of claim 24, further comprising:
asserting a first challenge read signal on a challenge memory bit cell column circuit among a plurality of first challenge memory bit cell column circuits in the first PUF challenge memory array, each challenge memory bit cell column circuit among the plurality of first challenge memory bit cell column circuits comprising at least one challenge memory bit cell among the plurality of first challenge memory bit cells in each of the plurality of first challenge memory bit cell row circuits;
asserting a second challenge read signal on a challenge memory bit cell column circuit among a plurality of second challenge memory bit cell column circuits in the second PUF challenge memory array, each challenge memory bit cell column circuit among the plurality of second challenge memory bit cell column circuits comprising at least one challenge memory bit cell among the plurality of second challenge memory bit cells in each of the plurality of second challenge memory bit cell row circuits; and
asserting a response read signal on a response memory bit cell column circuit among a plurality of response memory bit cell column circuits in the PUF response memory array, each response memory bit cell column circuit among the plurality of response memory bit cell column circuits comprising at least one response memory bit cell among the plurality of response memory bit cells in each of the plurality of response memory bit cell row circuits.

26. The method of claim 24, further comprising:
asserting a first challenge write signal on a challenge memory bit cell column circuit among a plurality of first challenge memory bit cell column circuits in the first PUF challenge memory array, each challenge memory bit cell column circuit among the plurality of first challenge memory bit cell column circuits comprising at least one challenge memory bit cell among the plurality of first challenge memory bit cells in each of the plurality of first challenge memory bit cell row circuits;
asserting a second challenge write signal on a challenge memory bit cell column circuit among a plurality of second challenge memory bit cell column circuits in the second PUF challenge memory array, each challenge memory bit cell column circuit among the plurality of second challenge memory bit cell column circuits comprising at least one challenge memory bit cell among the plurality of second challenge memory bit cells in each of the plurality of second challenge memory bit cell row circuits;
writing a first challenge write data word based on the first challenge write signal to the selected challenge memory bit cell row circuit in the first PUF challenge memory array;
writing a second challenge write data word based on the second challenge write signal to the selected challenge memory bit cell row circuit in the second PUF challenge memory array;
asserting a response write signal on a response memory bit cell column circuit among a plurality of response memory bit cell column circuits in the PUF response memory array, each response memory bit cell column circuit among the plurality of response memory bit cell column circuits comprising at least one response memory bit cell among the plurality of response memory bit cells in each of the plurality of response memory bit cell row circuits; and
writing a response write data word based on the response write signal to the selected response memory bit cell row circuit in the PUF response memory array.

27. The method of claim 23, further comprising:
determining a first challenge logic state skew of the at least one first challenge memory bit cell among the plurality of first challenge memory bit cells;
determining a second challenge logic state skew of the at least one second challenge memory bit cell among the plurality of second challenge memory bit cells; and
determining a response logic state skew of the accessed at least one response memory bit cell among the plurality of response memory bit cells;
causing a stress voltage to be applied to the at least one first challenge memory bit cell among the plurality of first challenge memory bit cells in the first PUF challenge memory array based on the determined first challenge logic state skew;
causing a stress voltage to be applied to the at least one second challenge memory bit cell among the plurality of second challenge memory bit cells in the second PUF challenge memory array based on the determined second challenge logic state skew; and
causing a stress voltage to be applied to the at least one response memory bit cell among the plurality of response memory bit cells in the PUF response memory array based on the determined response logic state skew.

28. The method of claim 27, further comprising:
writing a first challenge write data word to the at least one first challenge memory bit cell among the plurality of first challenge memory bit cells based on the determined first challenge logic state skew;
writing a second challenge write data word to the at least one second challenge memory bit cell among the plurality of second challenge memory bit cells based on the determined second challenge logic state skew; and
writing a response write data word to the at least one response memory bit cell among the plurality of response memory bit cells based on the determined response logic state skew.
